(19) United States
(12) Patent Application Publication
(10) Pub. No.: US 2020/0082483 A1
(43) Pub. Date: Mar. 12, 2020

(54) A METHOD OF, AND PROGRAMMABLE NETWORK FOR, OBTAINING OR PROVIDING PROFESSIONAL SERVICES OR ADVICE

(71) Applicant: BELLATOR PTY LTD, Queensland (AU)

(72) Inventors: Dale Watson, Sydney, New South Wales (AU); Stephen Kriticos, Sydney, New South Wales (AU)

(21) Appl. No.: 16/469,893

(22) PCT Filed: Dec. 14, 2017
(86) PCT No.: PCT/AU2017/051391

§ 371 Date: Jun. 14, 2019

(30) Foreign Application Priority Data
Dec. 14, 2016 (AU) 2016905183

(51) Int. Cl. G06Q 50/18; G06Q 30/06; G06Q 10/10; G06Q 40/04; G06Q 40/06

(52) U.S. Cl. CPC G06Q 50/18; G06Q 30/0611; G06Q 40/06; G06Q 40/04; G06Q 10/10

(57) ABSTRACT

In a first aspect of the present invention there is provided a terminal computer arranged for obtaining or providing professional services or advice. The terminal computer is arranged for communication with a programmable network. The programmable network comprises brief storage means for storing a brief of one or more professional service or advice seekers seeking a corresponding service or corresponding advice and professional service provider or advisor brief storage access means arranged for enabling access by one or more professional service providers or advisors to said brief storage means. The brief storage access means is further arranged for selective access by each of said one or more professional service providers or advisors to each said brief of said one or more professional service or advice seekers. In another aspect of the present invention there is provided a method of operating a the terminal computer.

### FIELD OF THE INVENTION

The present invention broadly relates to the field of E-services. More specifically it relates to professional services and advice including for example, but not limited to, professions comprising those relating to law, finance, accounting, engineering, design including graphic, book, print, web, environmental, information, interaction, experience, type, advertising, publishing, animation, game, transmedia, multi-media, motion graphics, fashion and other visual communication professions, architecture, geology, medicine, physiotherapy, podiatry and dentistry. More specifically it relates to obtaining or providing professional services or advice. More specifically still it relates to, but is not limited to, obtaining or providing Intellectual Property (‘IP’) services or advice. More specifically again it relates to, but is not limited to, obtaining registered IP rights, for example, those relating to patents, trademarks and designs.

### BACKGROUND OF THE INVENTION

E-services and E-commerce has grown rapidly over recent years and this growth rate is likely to increase in coming years. The expansion in this field is providing new opportunities for individuals and businesses to communicate and access information or services. It is also providing new ways for opinions, advice or products to be sought and provided or purchased. This is apparent, for example, at least by the increased importance for individuals and businesses to have an internet identity and presence.

Professional services or advice can be, and typically is, expensive. With respect to one particular profession, for example that relating to IP, in some cases IP owners or originators apply for corresponding registered IP rights themselves. This has cost benefits but can, for example, at least contribute to problems or difficulties in the applications, or deficiencies in any registered IP rights that may be obtained. Similar cost barriers exist in other professions, for example the financial or accounting professions where professional services provided by some of the established practices are prohibitively expensive for most people.

With respect to professions that are not necessarily prohibitively expensive there may not be the same cost barriers to obtaining professional services or advice although there are other difficulties. For example, there are a large number of advisors and they typically have different pricing, approaches, and their opinions may also differ, in relation to any particular matter. It is therefore difficult for persons seeking professional services or advice to compare advisors or practices or firms, either their pricing, approach or advice.

Concerning the legal profession, and in particular IP, advisors, for example, patent attorneys and IP lawyers, are typically engaged to provide advice in relation to the IP or to prepare and file patent applications applying for corresponding registered IP rights. Advisors are typically similarly engaged in relation to other IP, for example, IP comprising trademarks and designs.

Registered IP rights can be sought with the intention of, and prior to, commercialising the corresponding IP. In some cases, for example in relation to potentially patentable IP, it is also typically necessary or at least beneficial to apply for corresponding registered IP rights prior to commercialisation. This adds to the complexity and uncertainty of obtaining IP related professional services or advice.

The shortcomings of obtaining professional services or advice identified above possibly also impacts on some professional services advisors and their practices or firms. This is because the expense, difficulty in comparing professional services or advice and complexity referred to above may benefit established professional services practices or firms or practices or firms that for various reasons have greater access to potential clients.

It is therefore desirable to provide alternative means of obtaining or providing professional services or advice, which in at least one aspect, at least partly addresses one or more of the above described, or other, shortcomings.

### SUMMARY OF THE INVENTION

In one aspect of the present invention there is provided a method of applying for or obtaining registered IP rights comprising an agreement between an owner or originator of said IP or a prospective applicant of an application for registration of said registered IP rights, and a registering party, said registering party being authorised, by one or more corresponding registering organisations which grant or issue said registered IP rights, to act on behalf of said owner or originator or prospective applicant in relation to said registered IP rights, said method comprising the steps of:
a. payment by said owner or originator or prospective applicant to said registering party of an assessment fee for assessment of registrability of said IP; and
b. if said assessment is that the IP is at least likely to be registerable, agreement that said registering party will apply for said registered IP rights and said owner or originator or prospective applicant will pay to said registering party a percentage of revenue derived from exploitation of said IP.

Preferably said method of said one aspect further comprises the step of pursuing, at least to a substantially reasonable extent, registration of said registered IP rights. However, said revenue derived from said exploitation is preferably payable to said registering party irrespective of whether said registered IP rights are obtained.

In a preferred form of said one aspect of the present invention said percentage is a percentage of at least substantially all said revenue.

Preferably said registrability assessment is performed by said registering party. However, in an alternative preferred embodiment it is performed by a third party.

In a preferred form of said one aspect of the present invention said method further comprises the step of assessment of commercial merits or viability of said IP. In this further preferred form, the assessment fee also comprises assessment of said commercial merits or viability. Assessment of said commercial merits or viability is preferably performed by a commercialising party. In a more preferred embodiment said commercialising party is at least associated with said registering party, and more preferably said registering party comprises said commercialising party. However, alternatively said assessment of said commercial merits or viability is performed by a third party.

Preferably said assessment comprises a rating. In a more preferred form of said one aspect of the present invention, if said rating is greater than or equal to a predetermined value, said registering party agrees to one or more of: endeavouring, with at least reasonable diligence, to obtaining said registered IP rights; commercialisation advice; or commercialisation assistance. In a more preferred embodiment of said one aspect of the present invention said commercialisation advice or assistance comprises, for example, one or more of: prototyping; and market considerations and recommendations. In a still more preferred form of said one aspect of the present invention if said rating is greater than or equal to a predetermined value said method further comprises the step of registering party agreeing to do all things reasonably necessary for one or more of: lodgement with corresponding registry bodies, for example patent, trademark or design offices or their equivalents, of applications for said registered IP rights and obtaining said registered IP rights; protection or defence of any registered IP rights that have been obtained in relation to deregistration; and enforcement of any registered IP rights that have been obtained in relation to infringement or threatened infringement.

In a more preferred form of said one aspect of the present invention if said rating is greater than or equal to a predetermined value said registering party agrees to pay prescribed fees of said agreement. Said prescribed fees preferably comprise official fees, said official fees being those payable to said registering organisations. Preferably, said prescribed fees further comprise substantially all official fees. In a more preferred embodiment said prescribed fees further comprise substantially all other fees, for example, those of any other registering parties engaged by said registering party to apply for and obtain registered IP rights in relation to other jurisdictions.

In a still more preferred form of said one aspect of the present invention said assessment fee is at least substantial. For example, in one preferred embodiment said assessment fee is in the order of about $1,000-$20,000. More preferably said assessment fee is multi-tiered, different tiers corresponding to predetermined ranges of values of said rating. In a yet more preferred form of the present invention said assessment fee is payable at predetermined stages of a corresponding process of applying for or obtaining registered IP rights. For example, an initial assessment fee for assessment of the registrability of the IP and a subsequent fee relating to application(s) for registration and commercialisation of said IP.

Preferably said assessment fee is inversely proportional to said percentage of revenue derived from exploitation of said IP. For example, said assessment fee may be in the order of approximately $5,000 for a value of said percentage of revenue in the order of approximately 30%. However, if said percentage of said revenue is instead approximately 15% then said assessment fee may, for example, be in the order of approximately $15,000.

In another preferred form of said one aspect of the present invention the value of said assessment fee may additionally, or alternatively, be inversely proportional to the value of said rating. For example, for a rating of 4.5/5 said assessment fee may be in the order of $3,000 for a value of said percentage of said revenue of approximately 20%. However, for the same revenue percentage, if the value of the rating was instead 2 then the assessment fee may, for example, increase to $10,000.

In one preferred form of said one aspect of the present invention said method further comprises the step of utilising one or more capital raising platforms or applications, for example, ‘Crowd Funding’ by Google Inc. More preferably however said capital raising is only undertaken after applications relating to said step of said registering party applying for said registered IP rights have been filed with corresponding said registering organisations, or a decision has been made not to pursue such applications.

Another preferred embodiment of said one aspect of the present invention further comprises the step of assigning said IP from said owner or originator or prospective applicant to said registering party. Said method preferably further comprises the step of licencing back to said owner or originator or prospective applicant. Said licence is preferable exclusive and irrevocable. However, said licence may allow sub-licencing. More preferably said licence is of unlimited term. Still more preferably, said irrevocability is voided if revenue payable to said registering party is not paid to that party. Preferably said irrevocability is only voidable if said revenue is not paid without good reason.

In a still other preferred embodiment of said one aspect of the present invention said method further comprises the step of considering whether there may be a conflict of interest in carrying out steps of said method, and before disclosure of any information relating to said IP other than publically available information. This consideration step is also preferably carried out prior to payment of said assessment fee.

In a yet another preferred embodiment of said one aspect of the present invention any said steps agreed to by said registering party, or otherwise any agreement by said registering party in accordance with said method of applying for said registered IP rights, may be voided if one or more of the following apply and are relevant to said agreement: information known to but not disclosed by said owner or originator or prospective applicant to said registering party; information not revealed by searches of an appropriate standard; infringement of third party IP rights; it becomes apparent that the IP is not commercially viable or has limited commercial merit; said owner or originator or prospective applicant do not use their best endeavours to commercialise the IP; or advice or recommendations of the registering party is not implemented.

More preferably, said method of applying for registered IP rights of said one aspect of the present invention excludes litigation relating to said registered IP rights or third party IP rights whether or not registered.

In another aspect of the present invention there is provided a programmable network arranged for obtaining or providing legal services or advice, said programmable network comprising brief storage means for storing a brief of one or more legal service or advice seekers seeking a corresponding service or corresponding advice, and legal service provider or advisor brief storage access means arranged for enabling access by one or more legal service providers or advisors to said brief storage means, wherein said brief storage access means is further arranged for selective access by each of said one or more legal service providers or advisors to each said brief of said one or more legal service or advice seekers.

In a preferred form of said other aspect of the present invention said programmable network is further arranged for said service seeker to use or access said programmable network for the purpose of seeking said service. In a more preferred form said programmable network is further arranged for said service seeker to open an account in relation to said programmable network and thereby become an account holder of said programmable network.

In a preferred from of said other aspect of the present invention said brief storage access means further comprises time recording means arranged to record time spent by said one or more legal service providers or advisors viewing said brief. Preferably, said brief storage access means is further arranged to convert said viewing time to a corresponding charge.

More preferably, said charge is capped. More preferably still a predetermined amount of viewing time is stipulated to be free of charge. In a yet more preferred embodiment chargeable viewing time is required to be preapproved in relation to each said one or more legal service providers or advisors. In one preferred form of said other aspect of the present invention said service may comprise an opinion.

Preferably, said brief storage means is arranged for storing a plurality of briefs corresponding to a plurality of service seekers.

More preferably, said programmable network of said other aspect of the present invention further comprises communication facilitation means arranged for at least partially facilitating communication between any one or more of said one or more service seekers and any one or more of the following: any one or more of said one or more service providers; and any one or more other of said one or more service seekers. More preferably still, said communication facilitation means is further arranged for at least partially facilitating communication between any one or more of said one or more service providers and any one or more other of said one or more service providers. More preferably said communication facilitation means is arranged to provide communication channels which comprise or enable said communication.

Preferably said communication facilitation means comprises image capture means arranged for capturing an image. In one preferred form of said one aspect of the present invention said image capture means comprises, for example, software enabling a photograph or video for example to be taken that comprises said image. In a more preferred form of said one aspect of the present invention said image capture means comprises time delay means arranged for enabling or assisting, for example, said one or more service seekers to use their phone, for example, to take photographs of a component they are seeking advice in relation to. In relation to this more preferred form, said image capture means is more preferably arranged to allow a phone for example or other image capturing device such as a camera, once positioned for support, said one or more service seekers to, for example, turn or otherwise move said component while these are photographed in multiple photographs which capture said images which represent, for example, the front, side and back views of said component. More preferably still, said image capture means is further arranged to control the frame rate to capture images relating to a predetermined number of different angles, or predetermined angles, for example, one image relating to each of the following views: front; left side; right side; and rear. In a yet more preferred embodiment said image capturing means further comprises rotation determination means arranged to determine a speed of rotation of, for example, said component. In a still more preferred embodiment said image capturing means further comprises orientation detection means for determining an orientation of, for example, said component in order to determine said speed of rotation and hence also determine said controlled frame rate. In a still more preferred form of said other aspect of the present invention said image capturing means is further arranged for said multiple photographs to be converted into, for example, 3D images including for example images suitable for said virtual disclosure of said image.

In an alternative form of said other aspect of the present invention one or more of said brief storage means or said brief storage access means comprises said communication facilitation means.

In a more preferred form of said one aspect of the present invention said communication facilitation means comprises image display means arranged for displaying said image to one or more of the following: any one or more of said one or more service providers; and any one or more other of said one or more service seekers. Said image may, for example, further comprise text and data.

More preferably, said image display means further comprises two or more different displays. These different displays are also preferably separate from, and more preferably independent of, each other. In a still more preferred form of said other aspect of the present invention said image display means comprises a summary display or a discussion display, or both of these displays. Preferably, only said account holder is authorised to amend said summary display, or to copy from said summary display to said discussion display. More preferably, said image display means is arranged to provide a plurality of discussion displays corresponding to each said summary display. Preferably, said programmable network of said other aspect of the present invention further comprises discussion display storage means arranged for storing one or more of said plurality of discussion displays. More preferably, said programmable network further comprises discussion display disclosure means arranged for disclosing said discussion display to one or more of the following: one or more of said one or more service providers; and one or more of said one or more service seekers. In a more preferred form of said other aspect of said present invention, said discussion display disclosure means is further arranged to only disclose each of said plurality of discussion display to a single paid service provider. Therefore, with respect to this preferred embodiment, each said paid service provider is the only paid service provider involved in said discussion display that is disclosed to them and that they therefore have access to.

Preferably, said summary display is arranged for disclosure via said service provider brief storage access means. Therefore, with respect to this preferred form of said other aspect of the present invention, said summary display is, for example, arranged for disclosure to all said invitees.

In a preferred form of said other aspect of the present invention said communication facilitation means further comprises branching means arranged for branching one or more of said communication channels of one or more of said discussion displays into a plurality of communication channels. Preferably, said branching means is arranged to enable one or more new communication channels to be established which comprise one or more communicants of an earlier established communication channel. More preferably, said branching means is arranged to enable said communication of said earlier established communication channel to be incorporated, at least partially but preferably at least substantially entirely, into said one or more new communication channels. More preferably still, said branching means is arranged for each said new communication channel to be established without the knowledge of communicants of said earlier established communication channel other than those which are also communicants of each corresponding said new communication channel. An advantage of this preferred form of said other aspect of the present invention is that communication of a said communication channel can be tailored or adapted. For example, communication of a communication channel comprising comments of one or more communicants of that channel may, for example, be unhelpful or otherwise undesirable with respect either to said service seeker or other communicants of said communication channel. Using said branching means a new or fresh communication channel can therefore be established incorporating all communicants of said earlier established communication channel from which the new or fresh communication channel branched except, for example, said unhelpful or otherwise undesirable communicants. The communicants of said earlier established communication channel which are not included in, or invited to, said new or fresh communication channel are not aware of said new communication channel or its communication and are also not offended that they were not invited to it. In a still more preferred form of said branching means, said communication of said earlier established communication channel is edited before incorporation into said one or more new communication channels. Preferably, said editing comprises removal of some but preferably all said communication of said earlier established communication channel relating to or provided by said communicants of said earlier established communication channel that are not included in, or invited to, said new fresh communication channel.

More preferably said other aspect of said present invention further comprises booking means arranged for retaining or booking one or more of said one or more service providers for said service relating to one or more of said: brief; summary display; one or more discussion displays. In a preferred form said booking means is arranged to relate, for example, to one or more of the following: a non-physical meeting comprising said communication facilitation means of said other aspect of the present invention; a physical meeting where said service seeker and service provider meet in person; a virtual meeting where, for example, said service seeker and service provider meet virtually, for example, using respective Virtual Reality Headsets to view respective images. In a still more preferred form of said other aspect of the present invention said booking means is arranged for retaining or booking one or more bookings with respect to any particular combination of service seekers and service providers. Therefore, for example, a particular service seeker might retain or book a particular service provider, or in some cases might retain or book two or more service providers. Those two or more service providers might be retained or booked, for example, for a common meeting in which all service providers are present, physically or otherwise, in the same meeting. However, said booking means is more preferably arranged to enable, for example, multiple meetings, in person or otherwise, to be booked that involve said particular service seeker and said those two or more service providers.

In a more preferred form of said other aspect of the present invention said image display means is further arranged to display advertising. Preferably said advertising is paid. More preferably, said programmable network of said other aspect of the present invention is further arranged, at least, for obtaining limited details relating to said brief and more preferably disclosing said limited details to advertisers responsible for displaying said advertising. More preferably said programmable network may be further arranged for disclosing said limited details to third parties other than said advertisers, including for example retail outlets or fashion designers, that may seek to benefit from said limited details. More preferably still, said limited details are sufficient for said advertisers or other said third parties to tailor or target their marketing or advertising, for example, in one or more of the following respects: geographical locations or regions; demographics; said technical or non-technical fields; or in any other respect. For any one or more of these or other related purposes said programmable network preferably further comprises location determining technology, for example, cell power triangulation, GPS or RFID, or any other suitable means which is also referred to below, arranged for determining a location of said service seeker. More preferably, said location determining technology further comprises, for example, Bluetooth Low Energy (BLE), and more preferably, BLE in conjunction with virtual BLE beacons.

Location related data described above is useful for a number of reasons including the following. It can be used to personalise experiences. So in relation to said programmable network said service provider, for example, or any other persons or organisations interacting with said service seeker via said programmable network, can obtain information or analytics concerning said service seeker that enables this personalisation. This comprises, for example, knowing where said service seekers are, how long they are at these locations and what they are doing there. This information enables service providers or said other persons or organisations to offer services that better reflect customer needs or desires.

In another preferred embodiment of said other aspect of said programmable network, said programmable network further comprises credit receiving means arranged for receiving payment. Said payment may relate to any form of payment, for example, cash or credit card or direct debit and comprises, for example, payment relating to said paid advertising. In a more preferred embodiment said programmable network further comprises payment allocation means for allocating or apportioning said paid advertising payment, or part thereof, at least to one or more of the following: the owner or administrator of said programmable network; one or more of said service seekers.

In a more preferred form of said other aspect of said present invention said credit receiving means is further arranged for receiving or applying credit in relation to one or more of said one or more service seekers. Preferably, said credit is arranged for enabling said service seeker to obtain a service from one or more of said one or more service providers equivalent to a predetermined value. In a more preferred form, said credit applies to one or more of a plurality of programmable networks. More preferably, said service seeker agrees upon acceptance of said credit that it cannot be converted to cash or any other monetary equivalent and hence only has any value with respect to their use of said one or more of said plurality of programmable networks in respect of which said credit is deemed to apply.

More preferably, said credit receiving means is further arranged for notifying said one or more service seekers or one or more service providers but preferably both of these persons or groups in relation to said capped, predetermined or preapproved charge, or any other charge. More preferably still said credit receiving means is further arranged to enable any one or more of these or other charges to be increased, and more preferably only upon corresponding approval. In a yet more preferred embodiment said credit receiving means further comprises auto credit receiving means arranged for a predetermined payment to be automatically applied, for example by debiting a corresponding credit card, in relation to said one or more service seekers once their account falls below a predetermined amount. However, in a further preferred form said one or more service seekers are first notified and more preferably first have the opportunity to corresponding approve.

Preferably said programmable network further comprises other recording means arranged for recording one or more of the following: commercial aspects of any engagement relating to said service sought by said service seeker that a service provider agrees to or confirms; a location of said service seeker, for example, whether they are located in premises relating to said one or more service providers or in a department store that sells a product, for example clothing, that they seek a service in relation to. Preferably said location is determined using e.g. cell power triangulation, GPS or RFID, or any other suitable means. Preferably, said recording means is further arranged for determining or sending notifications, or both, to one or both of said one or more service seekers or said one or more service providers that relate to said location. Said notifications could, for example, relate to services or products that may be in the vicinity of said service seeker or service provider and be of interest to them in light of, for example, said service or said meeting. More specifically for example, said notification could for example comprise a notification provided via a phone of said service seeker or service provider relating to one or more of the following: traffic updates; cafes or other food outlets; exclusive offers for users of said programmable network of said other aspect of the present invention including for example exclusive access to other service providers for a specified time that day or over the coming weeks or months.

Preferably, said brief storage means is further arranged for identifying said one or more legal service or advice seekers. In a more preferred form of said programmable network, said brief storage access means is further arranged to selectively identify said one or more legal service or advice seekers with respect to any one or more of said one or more legal service providers or advisors, any one or more other of said one or more legal service or advice seekers, or both.

In a more preferred form of the system of the present invention said programmable network further comprises legal service provider or advisor storage means arranged for storing information relating to one or more of said one or more legal service providers or advisors. Said legal service provider or advisor storage means is preferably further arranged to selectively identify said one or more legal service providers or advisors with respect to any one or more other of said one or more legal service providers or advisors, any one or more of said one or more legal service or advice seekers, or both.

More preferably, said communication facilitation means is further arranged for at least partially facilitating selective communication between one or more of said one or more legal service or advice seekers and one or more of said one or more legal service or advice providers. Preferably, said communication facilitation means comprises one or more of: said time recording means; and one or more features of said brief storage access means relating to conversion of said viewing time to a corresponding charge. More preferably still, said communication facilitation means is further arranged for at least partially facilitating selective communication at least between one or more of said one or more legal service providers or advisors and one or more other of said one or more legal service providers or advisors. In a yet more preferred embodiment said communication facilitation means is further arranged for at least partially facilitating selective communication between one or more of said one or more legal service or advice seekers and one or more other of said one or more legal service or advice seekers.

In one preferred form of said programmable network of the present invention said brief comprises IP of an owner or originator of said IP or a prospective applicant of an application for registration of corresponding registered IP rights, and said brief storage means correspondingly comprises IP storage means. However, said brief is not limited to IP. It could, for example, comprise a description of a legal matter not related to IP that said legal service or advice seeker is seeking corresponding services or advice in relation to.

Preferably, said programmable network comprises a programmable network arranged for applying for or obtaining registered IP rights. In relation to this preferred form of said programmable network said legal service provider or advisor storage means comprises registering parties storage means, said registering parties being authorised, by one or more registering organisations which grant or issue said registered IP rights, to act on behalf of said owner or originator or prospective applicant in relation to said IP with respect to said registered IP rights being applied for. In this more preferred form of the programmable network of the present invention said brief storage access means comprises IP storage access means arranged for enabling access by one or more of said one or more said registering parties to said IP storage means, wherein said IP storage access means is further arranged for selective access by each of said one or more registering parties in relation to said IP of each said owner or originator or prospective applicant.

Preferably, said IP storage access means comprises authorisation means arranged for authorising said access. In one preferred form of said other aspect of the present invention said authorisation means is arranged for any one or more of said owner or originator or prospective applicant to authorise one or more of said one or more registering parties to access their corresponding IP. In a yet more preferred form, said authorization means is arranged to authorize said access via an invitation of one or more of said owner or originator or prospective applicant to one or more of said one or more registering parties to access their corresponding IP. In a further preferred form of said programmable network said invitation comprises said registering parties of said registering parties storage means. However, alternatively said authorization means may be arranged to invite other registering parties.

More preferably said authorisation means is, additionally or alternatively, arranged for any one or more of said registering parties to authorize their access to IP of any one or more of said one or more owner or originator or prospective applicant. This preferred feature is preferably arranged to at least reduce any likelihood of said access by one or more of said one or more registering parties resulting in a conflict of interest.

More preferably said IP storage access means further comprises IP summary means for providing a summary of said IP relating to one or more of said one or more owner or originator or prospective applicant. With respect to this more preferred feature said authorization means is preferably further arranged to only authorize access in relation to each said summary by one or more of said one or more registering parties upon confirmation by a corresponding registering party that they have reviewed said summary and do not have a conflict of interest in acting in relation to the corresponding IP. More preferably, said IP summary only comprises publically available information relating to said IP. The publically available information is more preferably publically available anywhere throughout the world but at least with respect to the country in which said registering party resides. At least for this purpose said registering party storage means comprises information that identifies said registering party's jurisdiction or jurisdiction of practice, at least in relation to each said IP.

Preferably, said IP storage access means still further comprises IP feedback means, said IP feedback means comprising any information relating to said IP, and not only said publically available information, said IP feedback means being further arranged for disclosure of said any information relating to said IP only upon said authorisation of access in relation to a corresponding said IP summary and for receipt of an opinion or comments relating to said IP. In a preferred form, said IP feedback means enables, for example, said owner or originator or prospective applicant to easily or efficiently receive feedback relating to their IP and, for example, the commercial value of that IP. It also allows said feedback to be received in a confidential manner and as such prior to publication of said IP which typically occurs as part of the process of applying for registered IP rights. This feature of said programmable network is also likely to be of interest to said service providers not already acting in relation to said IP, because it provides another opportunity for them to add value and thereby be selected for provision of services in relation to said IP. By allowing multiple service providers to access information disclosed via said IP feedback means said IP feedback means increases, and in a preferred form greatly multiplies, the sources providing feedback in relation to said IP from a single service provider that is usually acting in relation to said IP, and that service provider's associates, to any number of service providers. In a preferred form said IP feedback means is therefore likely to accelerate assessment of said IP concerning, for example, validity or commercial prospects, and preferably at least both the aforementioned.

Preferably, the IP summary means is arranged to prompt said legal service or advice seeker for said summary. However, in a more preferred form of said other aspect of the present invention said summary is IP summary means is arranged to automatically prepare said summary. This more preferred form of said IP summary means preferably comprises one or more processors arranged to compare said brief with corresponding publically available information and prepare a summary relating to said brief that only comprises publically available information.

In an alternative form of said other aspect of the present invention said brief storage access means further comprises brief summary means corresponding to said IP summary means. Similarly, in another alternative form of said other aspect of the present invention said brief storage access means further comprises features corresponding to features of said IP storage access means.

Still more preferably said IP summary means does not identify any one or more of said one or more owners or originators or prospective applicants at least to any of said one or more registering parties. By virtue of this still more preferred feature a registering party can confirm whether or not they have a conflict of interest acting in relation to said IP relating to any one or more of said one or more owners or originators or said prospective applicants without the identity of the corresponding persons whom own or are developing said IP being revealed. This ensures a registering party of said one or more registering parties is not, without authorisation, notified that persons have or are developing IP in a particular field. It also enables said one or more owners or originators or said prospective applicants to consider alternative registering parties, or other said service providers or advisors, without revealing this to their current service provider or advisor.

In yet another more preferred embodiment of said other aspect of the present invention said IP storage access means comprises identity authorisation means arranged for identifying one or more of: one or more of said registering parties authorised by one or more of said one or more owners or originators or prospective applicants to act on their behalf; or one or more of said owner or originator or said prospective applicant which one or more of said registering parties authorises that they can act on behalf of.

In another preferred embodiment of said programmable network of said other aspect of the present invention said IP storage access means further comprises authorisation exclusion means arranged for identifying prospective clients or registering parties, including categories of prospective clients or registering parties, for whom said authorisation is not provided. For example, preferably said authorisation exclusion means is arranged to identify one or more of the following: specific organisations, companies or businesses; specific technologies or industries; individuals; small businesses, companies, organisations or institutions; or large businesses, companies, organisations or institutions. Preferably, said authorisation exclusion means is arranged for identifying excluded persons, organisations, technologies or industries by either or both said IP owner or originator or prospective applicant, or said registering parties.

In a preferred embodiment of said other aspect of the present invention said IP storage means is at least substantially secure to at least substantially ensure that access to it can only occur via said IP storage access means.

In a preferred form of said other aspect of the present invention said registering parties storage means is updated or modified by, for example, a said registering party or a third party. Said third party may, for example, comprise an administrator of said system.

More preferably said programmable network of said other aspect of the present invention comprises assessment means arranged for assessment by one or more of said one or more said registering parties of the registrability of said IP. Preferably, said assessment means is arranged to fulfill one or more steps of said assessment of said method of said one aspect of the present invention. More preferably, said assessment means is further arranged to assess said one or more registering parties, or correspondingly said one or more legal providers or advisors. Preferably, said assessment means is arranged to enhance or optimize interaction of said one or more legal service providers or advisors with said brief. Preferably said assessment means is arranged to enhance or optimize access of one or more of said one or more legal service provider or advisor seekers to one or more of said one or more legal service providers or advisors, or one or more of said one or more legal service providers or advisors to one or more other of said one or more legal service providers or advisors.

In a preferred embodiment of said programmable network of the present invention said assessment means comprises assessment selection means for selecting an assessment from a limited number of options, for example, from ratings of 1 to 5, where 5 indicates that the IP is registerable.

In a more preferred form of said other aspect of the present invention said programmable network further comprises proposal communication means for communicating a proposal by either one or more of said one or more legal service provider or advice seekers or one or more of said one or more registering parties, or both of these, of, for example, a service arrangement for provision of a corresponding legal service or advice to either one or more of one or more of said IP owner or originator or prospective applicant or one or more of said one or more registering parties, or both of these. Preferably, said proposal communication means comprises proposal selection means for selecting a proposal from a limited number of options comprising, for example, one or more of: an hourly charge basis; a fixed fee basis; and all-inclusive basis; or any one or more features of said agreement of said method of said one aspect of the present invention. In a still more preferred form of the other aspect of the present invention said programmable network further comprises agreement communication means arranged for confirming agreement between any one or more of said one or more IP owner or originator or prospective applicant and said one or more registering parties, or said one or more registering parties and any one or more other said one or more registering parties. This agreement may, for example, comprise a service or advice agreement. More preferably, said agreement communication means comprises agreement selection means for selecting an agreement derived from, for example, one or more said proposals of said proposal selection means.

In another preferred embodiment of said programmable network of said other aspect of the present invention said programmable network further comprises assessing means arranged for assessing one or more of said one or more service providers or service seekers, or both to determine whether respective disclosure of one or more of said brief, brief summary or service provider identify should be authorised. In one preferred embodiment said assessing means comprises one or more of said brief storage disclosure means, brief summary means, service provider storage means. More preferably said assessing means is further arranged for said programmable network or a designer, administrator or owner thereof, to recommend, determine or control matching of one or more of said one or more service providers or service seekers with other respective service seekers or service providers.

In a preferred embodiment of said programmable network of said other aspect of the present invention said assessing means further comprises assessing selection means for selecting an assessment from a limited number of options, for example, from ratings of 1 to 5, where 5 is the highest rating. More preferably said assessing means further comprises credentials storage means arranged for storing credentials of one or more of said one or more service providers or service seekers, or both. Preferably said assessment or credentials or both are populated by respective said one or more of said one or more service providers or service seekers, or by a designer, administrator or owner of said programmable network.

In a still more preferred embodiment said assessing means further comprises credentials storage disclosure means arranged for respective disclosure of said credentials to of one or more of said one or more service seekers or service providers, or both. More preferably still said credentials storage disclosure means is further arranged for disclosure of a credentials summary summarising said credentials. In a yet more preferred embodiment said credentials storage disclosure means further comprises credentials auto summary means arranged at least partially for automatically generating said credentials summary.

Preferably, said credentials storage disclosure means assists one or more of said one or more service seekers or one or more of said one or more service providers to respectively determine whether respective disclosure of one or more of said brief, brief summary or service provider identify should be authorised.

In another preferred embodiment of the other aspect of the present invention said programmable network further comprises commercial assistance means arranged for at least partially assisting one or more commercial aspects relating to said brief or said service corresponding to said brief that said service seeker is seeking said service in relation to. For example, said commercial aspects could comprise licensing or assigning said IP that said brief comprises and corresponding revenue or equity relating to said license or assignment. In one preferred form said commercial assistance means comprises, for example, said communication facilitation means of said other aspect of the present invention wherein said communication facilitation means is further arranged for communication with capital raising platforms or applications, for example, Crowd Funding Websites such as KickStarter. In another alternative embodiment, said commercial assistance means comprises, for example, said communication facilitation means of said other aspect of the present invention wherein said communication facilitation means is further arranged for communication with one or more commercial partners, including for example one or more of said service provider or advertiser with respect to said commercial aspects. The particular example of communication with commercial partners could, for example, comprise said communication facilitation means being arranged for said service provider to offer one or more services at a reduced charge or fee or for no charge or fee in return, for example, for a percentage of revenue or equity relating to said commercial aspects that said service provider is offering said service in relation to. Preferably, said programmable network is arranged to communicate with said capital raising platforms or applications only after said registered IP rights have been obtained, or a decision has been made to no longer pursue said registered rights.

Preferably, said programmable network of said other aspect of the present invention comprises the internet. More preferably, one or more programmable network features of said programmable network comprising, for example, one or more of said IP storage means, registering parties storage means, IP storage access means, authorization means, IP summary means, identity authorization means, authorization exclusion means, assessment means, assessment selection means, proposal communication means, agreement communication means, agreement selection means, and said arrangement for communication with said capital raising platforms or applications, are connected to the internet for operation at least partially via the internet or optional operation via the internet. More preferably still, said programmable network of the present invention comprises, for example, one or more of the following or each of the following: websites; Apps; personal computers; smart phones.

In a more preferred form of the programmable network of the other aspect of the present invention said programmable network features comprise, as appropriate and as would be understood from skilled persons in the relevant field, corresponding data storage and processing means which more preferably comprise corresponding electronic data storage and processing, and still more preferably, for example, one or more corresponding electronic hard drives and processors. More preferably, said programmable network comprises one or more computers or computer networks comprising said data storage and processing means.

In a yet another aspect of the present invention there is provided a method of operating a programmable network to obtain or provide legal services or advice, said method comprising the steps of storing a brief of one or more legal service or advice seekers seeking a corresponding service or corresponding advice, and one or more legal service providers or advisors selectively accessing each said brief of said one or more legal service or advice seekers. Preferably, said step of storing said brief comprises any suitable storage means, but more preferably comprises computing means, an IT system or any suitable means that would be readily understood by persons skilled in the relevant field.

In a still yet other aspect of the present invention there is provided a method of obtaining or providing legal services or advice, said method comprising the steps of storing a brief of one or more legal service or advice seekers seeking a corresponding service or corresponding advice, and one or more legal service providers or advisors selectively accessing each said brief of said one or more legal service or advice seekers.

Preferably, said brief storage step further comprises the step of storing a plurality of briefs corresponding to a plurality of service seekers.

More preferably, said method of operating a programmable network of said yet other aspect of the present invention further comprises the step of at least partially facilitating communication between any one or more of said one or more service seekers and any one or more of the following: any one or more of said one or more service providers; and any one or more other of said one or more service seekers. More preferably still, said communication facilitation step further comprises the step of at least partially facilitating communication between any one or more of said one or more service providers and any one or more other of said one or more service providers. More preferably said communication facilitation step further comprises the step of providing communication channels which comprise or enable said communication.

Preferably said communication facilitation step further comprises the step of capturing an image. In one preferred form of said one aspect of the present invention said image capturing step comprises, for example, software enabling a photograph or video for example to be taken that comprises said image. More preferably, said image capturing step comprises capturing images relating to a plurality of different views, for example: front; left side; right side; and rear. In a still more preferred form of said yet other aspect of the present invention said image capturing step further comprises the step of converting said photograph or video, for example, into, for example, 3D images including for example images suitable for said virtual disclosure of said image.

In a more preferred form of said yet other aspect of the present invention said communication facilitation step further comprises the step of displaying said image to one or more of the following: any one or more of said one or more service providers; and any one or more other of said one or more service seekers. Said image may, for example, further comprise text and data.

More preferably, said image display step further comprises the step of displaying two or more different displays. These different displays are also preferably separate from, and more preferably independent of, each other. In a still more preferred form of said yet other aspect of the present invention said image display step further comprises the step of displaying a summary display or a discussion display, or both of these displays. More preferably, said image display step further comprises the step of displaying a plurality of discussion displays corresponding to each said summary display. Preferably, said programmable network of said yet other aspect of the present invention further comprises the step of storing one or more of said plurality of discussion displays. More preferably, said programmable network further comprises the step of disclosing said discussion display to one or more of the following: one or more of said one or more service providers; and one or more of said one or more service seekers. In a more preferred form of said yet other aspect of said present invention, said discussion display disclosure step further comprises the step of only disclosing each of said plurality of discussion display to a single service provider. Therefore, with respect to this preferred embodiment, each said service provider is the only service provider involved in said discussion display that is disclosed to them and that they therefore have access to.

Preferably, said summary display step further comprises the step of disclosing said summary display to all said invitees.

In a preferred form of said yet other aspect of the present invention said communication facilitation step further comprises the step of branching one or more of said communication channels of one or more of said discussion displays into a plurality of communication channels. Preferably, said branching step further comprises the step of enabling one or more new communication channels to be established which comprise one or more communicants of an earlier established communication channel. More preferably, said branching step incorporates said communication of said earlier established communication channel, at least partially but preferably at least substantially entirely, into said one or more new communication channels. More preferably still, said branching step further comprises for each said new communication channel to be established without the knowledge of communicants of said earlier established communication channel other than those which are also communicants of each corresponding said new communication channel. An advantage of this preferred form of said yet other aspect of the present invention is that communication of a said communication channel can be tailored or adapted. For example, communication of a communication channel comprising comments of one or more communicants of that channel may, for example, be unhelpful or otherwise undesirable with respect either to said service seeker or other communicants of said communication channel. Using said branching step a new or fresh communication channel can therefore be established incorporating all communicants of said earlier established communication channel from which the new or fresh communication channel branched except, for example, said unhelpful or otherwise undesirable communicants. The communicants of said earlier established communication channel which are not included in, or invited to, said new or fresh communication channel are not aware of said new communication channel or its communication and are also not offended that they were not invited to it. In a still more preferred form of said branching step, said communication of said earlier established communication channel is edited before incorporation into said one or more new communication channels. Preferably, said editing comprises removal of some but preferably all said communication of said earlier established communication channel relating to or provided by said communicants of said earlier established communication channel that are not included in, or invited to, said new fresh communication channel.

More preferably said yet other aspect of said present invention further comprises the step of retaining or booking one or more of said one or more service providers for said service relating to one or more of said: brief; summary display; one or more discussion displays. In a preferred form said booking step is arranged to relate, for example, to one or more of the following: a non-physical meeting comprising said communication facilitation step of said yet other aspect of the present invention; a physical meeting where said service seeker and service provider meet in person; a virtual meeting where, for example, said service seeker and service provider meet virtually, for example, using respective Virtual Reality Headsets to view respective images. In a still more preferred form of said yet other aspect of the present invention said booking step further comprises retaining or booking one or more bookings with respect to any particular combination of service seekers and service providers. Therefore, for example, a particular service seeker might retain or book a particular service provider, or in some cases might retain or book two or more service providers. Those two or more service providers might be retained or booked, for example, for a common meeting in which all service providers are present, physically or otherwise, in the same meeting. However, said booking step more preferably further comprises enabling, for example, multiple meetings, in person or otherwise, to be booked that involve said particular service seeker and said those two or more service providers.

In a more preferred form of said yet other aspect of the present invention said image display step further comprises the step of displaying advertising. Preferably said advertising is paid. More preferably, said programmable network of said yet other aspect of the present invention further comprises, at least, the step of disclosing limited details of said brief to advertisers responsible for displaying said advertising. More preferably still, said limited details are sufficient for said advertisers to tailor or target their advertising, for example, in one or more of the following respects: geographical locations or regions; demographics; said technical or non-technical fields; or in any other respect.

In another preferred embodiment of said yet other aspect of said programmable network, said programmable network further comprises the step of receiving payment. Said payment may relate to any form of payment, for example, cash or credit card or direct debit and comprises, for example, payment relating to said paid advertising. In a more preferred embodiment said programmable network further comprises the step of allocating or apportioning said paid advertising payment, or part thereof, at least to one or more of the following: the owner or administrator of said programmable network; one or more of said service seekers.

In a more preferred form of said yet other aspect of said present invention said step of receiving credit further comprises the step of receiving or applying credit in relation to one or more of said one or more service seekers. Preferably, said credit receiving step further comprises the step of enabling said service seeker to obtain a service from one or more of said one or more service providers equivalent to a predetermined value. In a more preferred form, said credit receiving step further comprises the step of applying said credit to one or more of a plurality of programmable networks. More preferably, said credit receiving step further comprises the step of said service seeker agreeing upon acceptance of said credit that it cannot be converted to cash or any other monetary equivalent and hence only has any value with respect to their use of said one or more of said plurality of programmable networks in respect of which said credit is deemed to apply.

More preferably, said credit receiving step further comprises the step of notifying said one or more service seekers or one or more service providers but preferably both of these persons or groups in relation to said capped, predetermined or preapproved charge, or any other charge. More preferably still said credit receiving step further comprises the step of enabling any one or more of these or other charges to be increased, and more preferably only upon corresponding approval. In a yet more preferred embodiment said credit receiving step further comprises the step of automatically applying a predetermined payment, for example by debiting a corresponding credit card, in relation to said one or more service seekers once their account falls below a predetermined amount. However, in a further preferred form said automatic application step further comprises a preceding notification step and more preferably further comprising a preceding step of requiring corresponding approval.

Preferably said method of operating a programmable network further comprises another recording step for recording one or more of the following: commercial aspects of any engagement relating to said service sought by said service seeker that a service provider agrees to or confirms; a location of said service seeker, for example, whether they are located in premises relating to said one or more service providers. Preferably said location is determined using e.g. cell power triangulation, GPS or RFID, or any other suitable means. Preferably, said other recording step further comprises the step of determining or sending notifications, or both, to one or both of said one or more service seekers or said one or more service providers that relate to said location. Said notifications could, for example, relate to services that may be in the vicinity of said service seeker or service provider and be of interest to them in light of, for example, said service or said meeting. More specifically for example, said notification could for example comprise a notification provided via a phone of said service seeker or service provider relating to one or more of the following: traffic updates; cafes or other food outlets; exclusive offers for users of said programmable network of said yet other aspect of the present invention including for example exclusive access to other service providers for a specified time that day or over the coming weeks or months.

In a preferred from of said yet other and still yet other aspects of the present invention said method further comprises the step of recording time spent by said one or more legal service providers or advisors viewing said brief. Preferably, said method further comprises the step of converting said viewing time to a corresponding charge. More preferably, said charge is capped. More preferably still the method further comprises the step of not converting a predetermined amount of viewing time to a corresponding charge so that the predetermined time is provided free of charge by the said one or more legal service providers or advisors. A yet more preferred embodiment further comprises the step of preapproving chargeable viewing time in relation to each said one or more legal service providers or advisors.

Preferably, said step of storing said brief further comprises the step of identifying said one or more legal service or advice seekers. In a more preferred form said method of said yet other and still yet other aspects of the present invention further comprises the step of selectively identifying said one or more legal service or advice seekers with respect to any one or more of said one or more legal service providers or advisors, any one or more other of said one or more legal service or advice seekers, or both.

More preferably, said method of said yet other and still yet other aspects of the present invention further comprises the step of storing information relating to one or more of said one or more legal service providers or advisors. More preferably still, this step further comprises the step of selectively identifying said one or more legal service providers or advisors with respect to any one or more other of said one or more legal service providers or advisors, any one or more of said one or more legal service or advice seekers, or both.

In a more preferred embodiment said method of said yet other and still yet other aspects of the present invention further comprises the step of selective communication between one or more of said one or more legal service or advice seekers and one or more of said one or more legal service or advice providers. Preferably, this step further comprises one or more steps of: recording a period of time of said selective communication; and converting said period of time of said selective communication to a corresponding charge. More preferably still, said method of said yet other and still yet other aspects of the present invention further comprises the step of selective communication at least between one or more of said one or more legal service providers or advisors and one or more other of said one or more legal service providers or advisors. A yet more preferred embodiment further comprises the step of selective communication between one or more of said one or more legal service or advice seekers and one or more other of said one or more legal service or advice seekers.

In one preferred form of said method of said yet other and still yet other aspects of the present invention said brief comprises IP of an owner or originator of said IP or a prospective applicant of an application for registration of corresponding registered IP rights. However, said brief is not limited to IP. It could, for example, comprise a description of a legal matter not related to IP that said legal service or advice seeker is seeking corresponding services or advice in relation to.

Preferably, said method of said yet other and still yet other aspects of the present invention comprise a method of applying for or obtaining registered IP rights. In relation to this preferred form of said method of obtaining or providing legal services or advice said step of storing legal service provider or advisor information comprises the step of storing registering parties, said registering parties being authorised, by one or more registering organisations which grant or issue said registered IP rights, to act on behalf of said owner or originator or prospective applicant in relation to said IP with respect to said registered IP rights being applied for. This more preferred form of said method of said yet other and still yet other aspects of the present invention preferably further comprises the step of one or more of said one or more said registering parties selectively accessing each said IP of each said owner or originator or prospective applicant.

Preferably, said selectively accessing step further comprises the step of authorising said access. This authorising step preferably further comprises the step of any one or more of said owner or originator or prospective applicant authorising one or more of said one or more registering parties to access their corresponding IP. In a yet more preferred form, said authorising step further comprises the step of authorising said access via an invitation of one or more of said owner or originator or prospective applicant to one or more of said one or more registering parties to access their corresponding IP. In a further preferred form of said method of said yet other and still yet other aspects of the present invention said invitation comprises said registering parties. However, alternatively said authorising step may further comprise the step of inviting other registering parties, other than those the subject of the step defined above of storing registering parties information.

More preferably, said method of said yet other and still yet other aspects of the present invention further comprises the additional or alternative step of any one or more of said registering parties authorising their access to said IP of any one or more of said one or more owner or originator or prospective applicant. This preferred feature is preferably arranged to at least reduce any likelihood of said access by one or more of said one or more registering parties resulting in a conflict of interest.

More preferably, said step of authorising access to said IP further comprises the preceding step of providing an IP summary summarising said IP relating to one or more of said one or more owner or originator or prospective applicant. More preferably still, said access authorization step further comprises the step of authorising access only in relation to each said summary by one or more of said one or more registering parties upon confirmation by a corresponding registering party that they have reviewed said summary and do not have a conflict of interest in acting in relation to the corresponding IP. More preferably, said step of providing an IP summary further comprises the step of only including publically available information in said summary. The publically available information is more preferably publically available anywhere throughout the world but at least with respect to the country in which said registering party resides. At least for this purpose said step of storing registering party information further comprises the step of including information that identifies said registering party's jurisdiction or jurisdiction of practice, at least in relation to each said IP.

Preferably, said access authorisation step further comprises the subsequent step of obtaining feedback relating to said IP, said IP feedback step comprising disclosure of any information relating to said IP, and not only said publically available information, but only upon said authorisation of access in relation to a corresponding said IP summary and for receipt of an opinion or comments relating to said IP. In a preferred form, said IP feedback step enables, for example, said owner or originator or prospective applicant to easily or efficiently receive feedback relating to their IP and, for example, the commercial value of that IP. It also allows said feedback to be received in a confidential manner and as such prior to publication of said IP which typically occurs as part of the process of applying for registered IP rights. This feature of said method of operating a programmable network is also likely to be of interest to said service providers not already acting in relation to said IP, because it provides another opportunity for such service providers to add value and thereby be selected for provision of services in relation to said IP. By allowing multiple service providers to access information disclosed via said IP feedback step said IP feedback step increases, and in a preferred form greatly multiplies, the sources providing feedback in relation to said IP from a single service provider that is usually acting in relation to said IP, and that service provider's associates, to any number of service providers. In a preferred form said IP feedback step is therefore likely to accelerate assessment of said IP concerning, for example, validity or commercial prospects, and preferably at least both of the aforementioned.

Preferably, said step of providing said IP summary further comprises the step of prompting said legal service or advice seeker for said summary. However, in a more preferred form of said yet other aspect of the present invention said step of providing said IP summary further comprises the step of automatically preparing said summary without further input from said legal service or advice seeker. In this more preferred form said IP summary means preferably comprises one or more processors arranged to compare said brief with corresponding publically available information and prepare a summary relating to said brief that only comprises publically available information.

In an alternative form of said yet other and still yet other aspects of the present invention said step of storing said brief further comprises steps corresponding to said steps of providing said IP summary. Similarly, in another alternative form of said yet other and still yet other aspects of the present invention said step of accessing said brief further comprises steps corresponding to said steps of selectively accessing said IP.

Still more preferably said step of enabling selective access to said IP summary further comprises the step of enabling any one or more of said one or more owners or originators or prospective applicants not to be identified at least to any of said one or more registering parties. By virtue of this still more preferred feature a registering party can confirm whether or not they have a conflict of interest acting in relation to said IP relating to any one or more of said one or more owners or originators or said prospective applicants without the identity of the corresponding persons whom own or are developing said IP being revealed. This ensures a registering party of said one or more registering parties is not, without authorisation, notified that persons have or are developing IP in a particular field. It also enables said one or more owners or originators or said prospective applicants to consider alternative registering parties, or other said service providers or advisors, without revealing this to their current service provider or advisor.

In yet another more preferred embodiment of said yet other and still yet other aspects of the present invention said step of accessing said IP further comprises the step of identifying one or more of: one or more of said registering parties authorised by one or more of said one or more owners or originators or prospective applicants to act on their behalf; or one or more of said owner or originator or said prospective applicant which one or more of said registering parties authorises that they can act on behalf of.

In another preferred embodiment said method of said yet other and still yet other aspects of the present invention said step of accessing said IP further comprises the step of identifying prospective clients or registering parties, including categories of prospective clients or registering parties, for whom said authorisation is not provided. For example, preferably one or more of the following are identified: specific organisations, companies or businesses; specific technologies or industries; individuals; small businesses, companies, organisations or institutions; or large businesses, companies, organisations or institutions. Preferably, said identification step comprises either or both said IP owner or originator or prospective applicant, or said registering parties.

In a preferred embodiment of said yet other and still yet other aspects of the present invention said step of storing said IP further comprises the step of at least substantially securely storing said IP to at least substantially ensure that access to it can only occur via said step of accessing said IP.

In a preferred form of said yet other and still yet other aspects of the present invention information relating to said registering parties is updated or modified by, for example, a said registering party or a third party. Said third party may, for example, comprise an administrator of said system.

More preferably said method of said yet other and still yet other aspects of the present invention further comprises the step of one or more of said one or more said registering parties assessing registrability of said IP. Preferably, said assessment step further comprises one or more steps of said assessment of said method of said one aspect of the present invention. More preferably, said assessment step further comprises the step of assessing said one or more registering parties, or correspondingly said one or more legal providers or advisors. Preferably, one or more of said assessment steps are arranged to enhance or optimize interaction of said one or more legal service providers or advisors with said brief. More preferably, one or more of said assessment steps are arranged to enhance or optimize access of one or more of said one or more legal service provider or advisor seekers to one or more of said one or more legal service providers or advisors, or one or more of said one or more legal service providers or advisors to one or more other of said one or more legal service providers or advisors.

In a preferred embodiment of said method of said yet other and still yet other aspects of the present invention one or more of said assessment steps further comprises the step of selecting an assessment from a limited number of options, for example, from ratings of 1 to 5, where 5 indicates that the IP is registerable.

In a more preferred form of said yet other and still yet other aspects of the present invention said method further comprises the step of communicating a proposal by either one or more of said one or more legal service provider or advice seekers or one or more of said one or more registering parties, or both of these, of, for example, a service arrangement for provision of a corresponding legal service or advice to either one or more of one or more of said IP owner or originator or prospective applicant or one or more of said one or more registering parties, or both of these. Preferably, said proposal communication step further comprises the step of selecting a proposal from a limited number of options comprising, for example, one or more of: an hourly charge basis; a fixed fee basis; and all-inclusive basis; or any one or more features of said agreement of said method of said one aspect of the present invention. In a still more preferred form of the yet other and still yet other aspects of the present invention said method further comprises the step of communicating confirmation of agreement between any one or more of said one or more IP owner or originator or prospective applicant and said one or more registering parties, or said one or more registering parties and any one or more other said one or more registering parties. This agreement may, for example, comprise a service or advice agreement. More preferably, said communication step further comprises the step of selecting an agreement derived from, for example, one or more said proposals of said limited number of proposals.

In another preferred embodiment of said yet other aspect of the present invention said method of operating a programmable network further comprises the step of providing commercial assistance for at least partially assisting one or more commercial aspects relating to said brief or said service corresponding to said brief that said service seeker is seeking said service in relation to. For example, said commercial aspects could comprise licensing or assigning said IP that said brief comprises and corresponding revenue or equity relating to said license or assignment. In one preferred form said step of providing commercial assistance comprises, for example, said communication facilitation step of said yet other aspect of the present invention wherein said communication facilitation step further comprises the step of communicating with capital raising platforms or applications, for example, Crowd Funding Websites such as KickStarter. In another alternative embodiment, said step of providing commercial assistance further comprises, for example, said communication facilitation step of said yet other aspect of the present invention wherein said communication facilitation step further comprises the step of communicating with one or more commercial partners, including for example one or more of said service provider or advertiser with respect to said commercial aspects. The particular example of communication with commercial partners could, for example, comprise said service provider offering one or more services at a reduced charge or fee or for no charge or fee in return, for example, for a percentage of revenue or equity relating to said commercial aspects that said service provider is offering said service in relation to.

Preferably, said commercial assistance step is subsequent to said registered IP rights have been obtained, or a decision being made to no longer pursue said registered rights.

Preferably, said method of said yet other and still yet other aspects of the present invention comprises the internet. More preferably, one or more features of said programmable network of said method of said yet other aspect of the present invention, said features comprising, for example, said IP storage, registering parties storage, IP access, authorization, summarizing said IP, authorization, authorization exclusion, assessment, assessment selection, proposal communication, agreement communication, agreement selection, and communication with said capital raising platforms or applications, are connected to the internet for operation at least partially via the internet or optional operation via the internet. In a more preferred form of the method of the yet other and still yet other aspects of the present invention said method steps comprise, as appropriate and as would be understood from skilled persons in the relevant field, data storage and processing. More preferably, said data storage and processing comprise corresponding electronic data storage and processing, and still more preferably, for example, one or more corresponding electronic hard drives and processors, and yet more preferably still, one or more computers or computer networks comprising said data storage and processing means. More preferably still, said method of said yet other aspect of the present invention comprises, for example, one or more of the following or each of the following: websites; Apps; personal computers; smart phones.

In an alternative form of said other aspect or said yet other and still yet other aspects of the present invention, said programmable network doesn't necessarily comprise the internet. In this alternative form it instead, or in addition, comprises one or more computers or computer networks. This alternative form of said other aspect of the present invention is suitable, for example, for intra organization use, for example the use described in the present description within a firm or company of lawyers or patent attorneys.

The programmable network of said other and yet other and still yet other aspects of the present invention may, for example, alternatively comprise a programmable apparatus or computer network.

Preferably said programmable network comprises one or more of the following: a terminal computer; a transmission medium. More preferably, said transmission medium is arranged for the transmission of data to or from said terminal computer.

In an alternative form of said other, yet other and still yet other aspects of the present invention said legal services or advice comprises professional services or advice. In this alternative form said professional services or advice comprises, for example, professions comprising those relating to one or more of the following: law, finance, accounting, engineering, design including graphic, book, print, web, environmental, information, interaction, experience, type, advertising, publishing, animation, game, transmedia, multi-media, motion graphics, fashion and other visual communication professions, and architecture. However, the professional services or advice can comprise any other professions.

In an alternative preferred embodiment, said other, yet other and still yet other aspects of the present invention comprise features equivalent to those relating to said registered IP rights with respect to said alternative form of said other, yet other and still yet other aspects of the present invention relating to professional services or advice unrelated to registered IP.

“Network” as used in the present description is also not limited, for example, to a network of computers, whether or not those computers are connected via the internet. It is instead a network in the sense of a physical (visible or invisible) construction arranged to connect said legal service or advice seeker with said legal service advisor or provider, or to connect said legal service or advice seekers with each other or said legal service advisors or providers with each other. In light of this definition of “network”, and the remainder of the specification, it is also to be understood that “network” is not limited to computers or corresponding electronic data storage or processors which computers typically comprise, nor to electronic or electrical communication which is typical of electronic data storage and processors. It could, for example, instead comprise: corresponding light-based processors and a fibre optic network; electronic data storage and processors and a satellite network; or the network could, for example, partly comprise electronic data storage and processors and electronic or electrical communication but also partly comprise other means of storage, processing and communication.

For ease of reference purposes only said legal service provider or advisor and said legal service or advice seeker are also equivalently referenced throughout the present specification by the respective phrases “service provider” and “service seeker”. Brief storage access means of said other aspect of the present invention can, for the purpose of the detailed description of the preferred embodiment section of the present specification and as appropriate, be substituted by brief storage disclosure means which is essentially an equivalent mirror image feature.

All prior art disclosures referenced directly or indirectly in the present specification, and any related documents, acts, materials, devices, articles, methods or the like, is solely for the purpose of providing context for the present invention. It is not to be taken as an admission that any or all of what is disclosed in relation to these disclosures forms part of the prior art base or was common general knowledge in the field relevant to the present invention as it existed in Australia or elsewhere before the priority date of each claim of the present specification.

### BRIEF DESCRIPTION OF THE DRAWINGS

Preferred embodiments of the present invention will now be described, by way of example only, with reference to the accompanying drawings in which:

FIG. 1 is a schematic diagram of one example of a method of the present invention in the form of a method of applying for registered patent rights;

FIG. 2 is a schematic diagram of another example of a method of the present invention in the form of a method of applying for registered trademark rights;

FIG. 3 is a schematic diagram of one example of a system of the present invention relating to a method similar to that of FIG. 1 with respect to a single registering party of the present invention;

FIG. 4 is a schematic diagram of another example of a system of the present invention of FIG. 3 but with respect to multiple registering parties of the present invention;

FIG. 5 is a schematic diagram of another example of a programmable network of the present invention for obtaining a service which in this particular example relates to mergers and acquisitions;

FIG. 6 is a schematic diagram of another example of the programmable network of FIG. 5 which includes one example of summary means of said other aspect of the present invention for providing a summary of said brief;

FIG. 7 is a schematic diagram of another example similar to that of FIG. 6 except that it shows a different example of said communication facilitation means of said other aspect of the present invention which comprises a LAN;

FIG. 8a is a schematic diagram of another example similar to that of FIGS. 6 and 7 except that it shows another example of communication facilitation means of said other aspect of the present invention which comprise particular examples of image capture means of the present invention;

FIG. 8b is a schematic diagram of another example similar to that of FIGS. 6 and 7 except that it shows another example of communication facilitation means of said other aspect of the present invention which comprise particular examples of summary and discussion displays of the present invention;

FIG. 8c is a schematic diagram of another example similar to that of FIGS. 6 and 7 except that it shows an example of booking means of the present invention;

FIG. 8d is a schematic diagram of another example similar to that of FIGS. 8c showing an example of an in-person meeting of said other aspect of the present invention;

FIG. 9 is a schematic diagram of another example of a programmable network of said other aspect of the present invention comprising one example of a plurality of programmable networks which are separate from each other and arranged for independent use and operation;

FIG. 10 is a schematic diagram showing one example of revenue flow relating to the plurality of programmable networks of FIG. 9; and

FIG. 11 shows another example of the programmable network of FIG. 6 including one example of branching means of said other aspect of the present invention.

### DETAILED DESCRIPTION OF THE PREFERRED EMBODIMENT

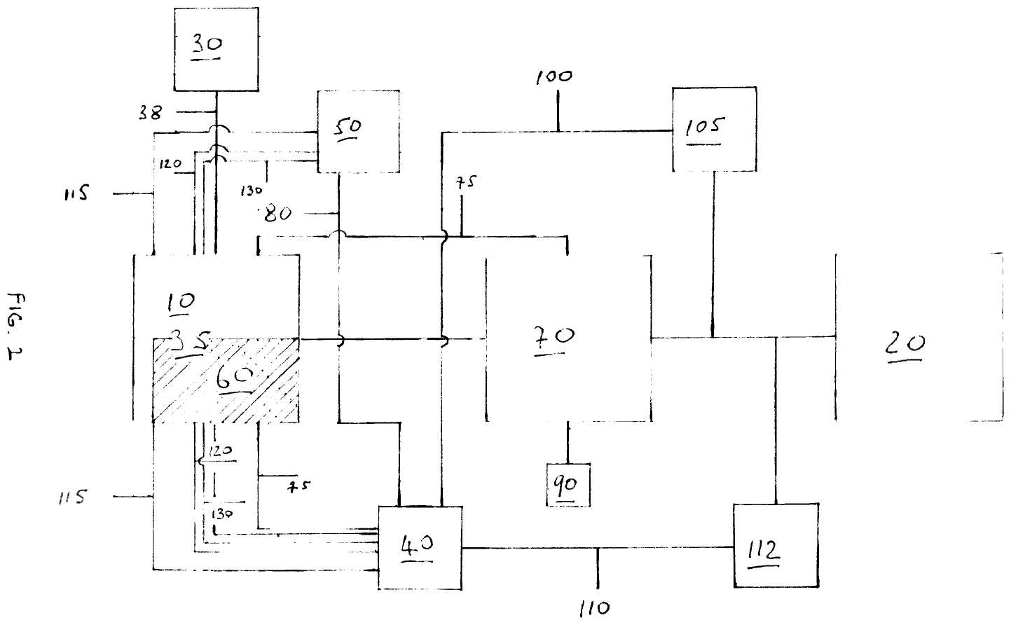

Referring to FIG. 1, a method of applying for or obtaining registered IP rights of the present invention, in this particular example, comprises a method of applying for registered patent rights 20. An originator of IP 10 corresponding to the registered patent rights 20 comprises an inventor 30 of the corresponding invention 35. Inventor 30 and her business partner, together a prospective applicant of the present invention which in this particular example comprises co-applicants 50, engage 38 a registering party of the present invention which in this particular example comprises Patent Filers 40. Co-applicants 50 require advice about obtaining the registered patent rights 20. They also require advice concerning commercial merits of the present invention which in this particular example comprise commercial merits 60 of the invention 35.

The method of applying for or obtaining registered patent rights 20 comprises an assessment fee of the present invention which in this particular example is assessment fee 80 of $3,000. The assessment fee 80 comprises an assessment of the present invention which in this particular example comprises assessment 70 of the registrability and commercial merits 75 of the invention 35. The assessment 70 comprises a rating of the present invention which in this particular example is rating 90. The value of the rating 90 is ⅘.

The rating 90 is greater than or equal to a predetermined value of the present invention which in this particular example is 4. Patent Filers 40 therefore agree that in addition to applying for registered patent rights 20 on behalf of the co-applicants 50, they will reasonably pursue grant or issuance of registered patent rights 20. Patent Filers 40 also additionally agree, due also to the value of the rating 90 being 4, to reasonably assist and advise in relation to commercialisation. Furthermore, due to the value of the rating 90 Patent Filers 40 also agree to pay all official fees 100 payable to registering bodies of the present invention, which in this particular example comprise patent offices 105 of jurisdictions of the registered patent rights 20. And because the value of the rating 90 is 4 Patent Filers 40 also agree to pay fees 110 of other registering parties 112 of the present invention which in this particular example comprise associates engaged by Patent Filers 40 in respect of jurisdictions of the registered patent rights 20 for which Patent Filers 40 are not authorised to act on behalf of the co-applicants 50.

In accordance with the method of applying for or obtaining registered patent rights 20, co-applicants 50 agree to pay Patent Filers 40 a percentage of revenue of the present invention which in relation to patent rights 20 comprises revenue percentage 115 of 30% of all revenue derived from exploitation of the IP 10. Co-applicants 50, also in accordance with the method of applying for registered patent rights 20, agree to assign 120 registered patent rights 20 to Patent Filers 40 and Patent Filers 40 exclusively and irrevocably licence 130 co-applicants 50 to exploit the invention 35.

If the co-applicants 50 do not reasonably endeavor to exploit the invention 35 or implement the commercialisation advice of Patent Filers 40 then Patent Filers 40 may, in accordance with their agreement with co-applicants 50, choose to not continue paying the fees 100 or 110.

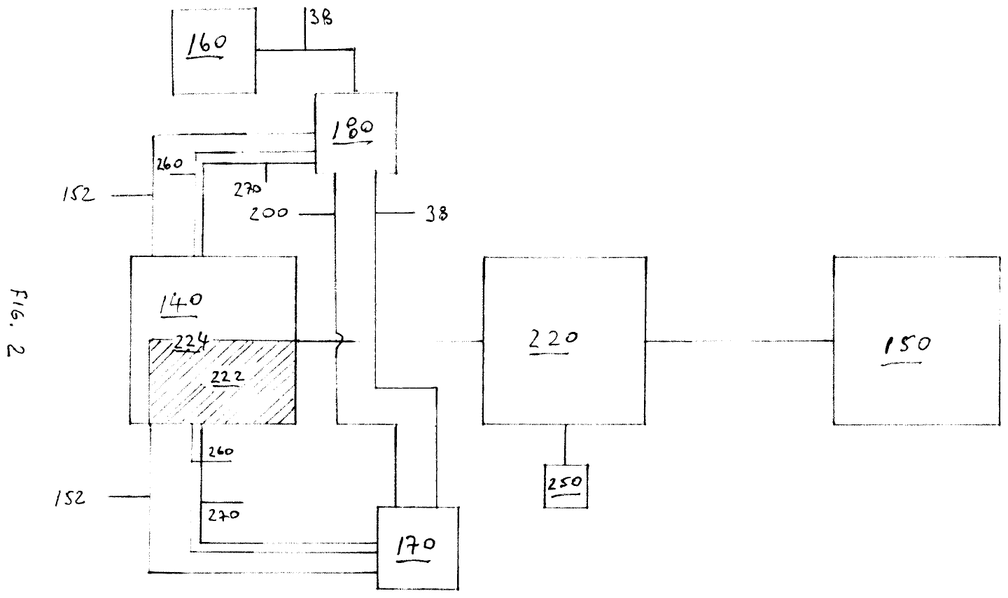

Referring to FIG. 2, a method of applying for or obtaining registered IP rights of the present invention, in this particular example, comprises a method of applying for or obtaining registered trademark rights 150. An originator of IP 140 corresponding to the registered trademark rights 150 comprises trademark originator 160. The trademark originator 160 engages 38 a registering party of the present invention which in this particular example comprises Patent and Trademark Filers 170. Trademark originator 160, a prospective applicant of the present invention in the form of applicant 180, requires advice about obtaining the registered trademark rights 150.

The method of applying for or obtaining registered trademark rights 150 comprises an assessment fee of the present invention which in this particular example is assessment fee 200 of $1,000. The assessment fee 200 comprises an assessment of the present invention which in this particular example comprises assessment 220 of the registrability 222 of trademarks 224 of the IP 140. The assessment 220 comprises a rating of the present invention which in this particular example is rating 250. The value of the rating 250 is ⅗.

The rating 250 is greater than or equal to a predetermined value of the present invention which in this particular example is 2. Patent and Trademark Filers 170 therefore agree that in addition to applying for registered trademark rights 150 on behalf of the applicant 180, they will reasonably pursue registration of the registered trademark rights 150.

In accordance with the method of obtaining registered trademark rights 150, the applicant 180 agrees to pay Patent and Trademark Filers 170 a percentage of revenue of the present invention which in relation to the method of applying for or obtaining trademark rights 150 comprises revenue percentage 152 of 15% of all revenue derived from exploitation of the IP 140. Applicant 180, also in accordance with the method of applying for or obtaining registered trademark rights 150, agrees to assign 260 the registered trademark rights 150 to Patent and Trademark Filers 170 and Patent and Trademark Filers 170 exclusively and irrevocably licence 270 applicant 180 to exploit the IP 140.

If applicant 180 does not reasonably endeavor to exploit the IP 140, Patent and Trademark Filers 170 may choose to not continue pursuing registered trademark rights 150.

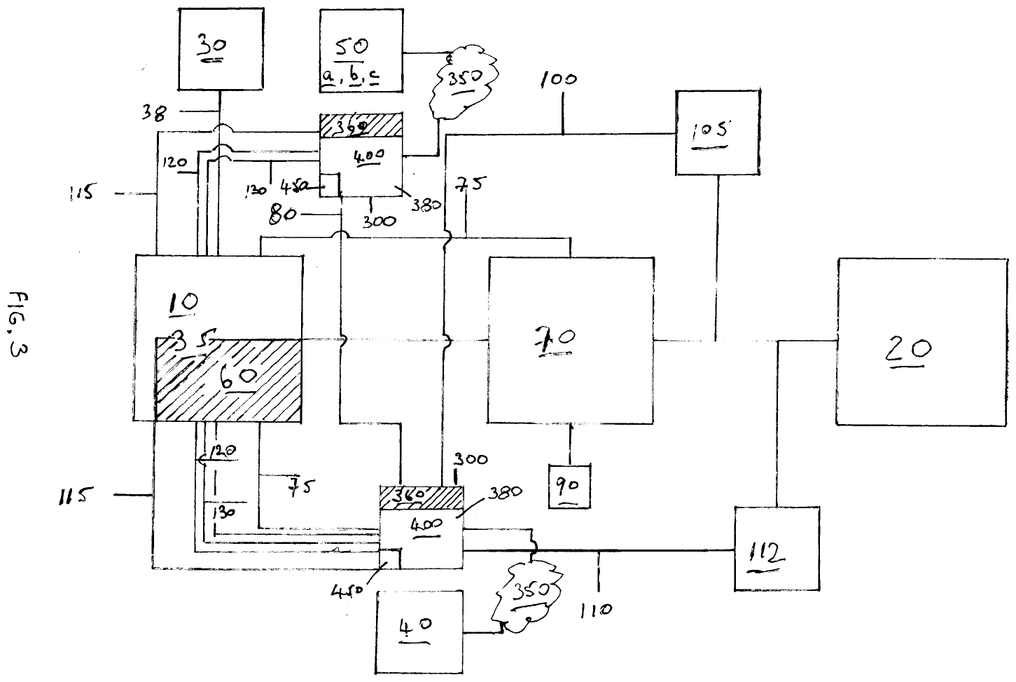

Referring to FIG. 3, one example of a programmable network of said other aspect of the present invention comprises a registered IP rights platform 300. The registered IP rights platform 300, in this particular example, is web based and connects via the internet 350 to an owner or originator of IP or a prospective applicant of an application for registration of corresponding registered IP rights of the system of the present invention. In this particular example, the registered IP rights platform 300 also connects, via the internet 350, applicants 50a, 50b, 50c etcetera via corresponding terminal computers of the present invention which may, for example, comprise a pc or phone. These applicants in turn become connected via the IP rights platform 300 and the internet 350 to registering parties of the system of the present invention which in this particular example comprise Patent Filers 40. The Patent Filers 40 are similarly connected via the internet 350 as explained via corresponding terminal computers of the present invention which may, for example, comprise a pc or phone.

The registered IP rights platform 300 of this particular example one or more computers having data storage and processing capability. The data storage capability comprises IP storage means of the other aspect of the present invention which in this particular example comprises a secure IP section 360 of the platform 300. The secure IP section 360, in this particular example, comprises one or more hard drives and is designed so that IP corresponding to each applicant 50a, 50b, 50c etc is only visible to the corresponding applicant. The design of the secure IP section 360 comprises appropriate security features including for example password protection and 128 Bit encryption. However, it also includes any other security features that would be readily apparent to persons skilled in the relevant field.

The secure IP section 360 is connected to Patent Filers 40 via IP storage access means of the programmable network of the present invention which in this particular example comprises secure IP access section 380. The data processing capability of the IP rights platform 300 comprises the secure IP access section 380 which in this particular example comprises one or more computers comprising processors. The secure IP access section 380 is designed to control access to the IP section 360 by Patent Filers 40. It is also designed to separately control access to IP corresponding to each applicant 50a, 50b, 50c etc.

In relation to IP data corresponding to each applicant 50a, 50b, 50c etc, before Patent Filers 40 can access that data the secure IP access section 380 requires Patent Filers 40 to review a corresponding summary of the IP. The summary is provided by IP summary means of said other aspect of the present invention which in this particular example comprises abstracts 400. The abstracts 400 comprise only publically available information and do not reveal information relating to the corresponding applicant 50a, 50b, 50c etc, including their name or any other details. Based on their review of one or more abstracts 400 Patent Filers 40 confirm via the secure IP access section 380 whether or not they can act in relation to the corresponding IP without a conflict of interest.

The secure IP access section 380 also excludes Patent Filers 40 from IP abstracts 400 which are excluded by identity authorization exclusion means of said other aspect of the present invention which in this particular example comprises exclusion from access list 450. The exclusion from access list 450 quarantines IP corresponding to applicants 50a, 50b, 50c etc from access by Patent Filers 40 if, for example, either the applicants 50a, 50b, 50c etc or the technology of their corresponding IP has been identified, in this particular example, as being included in the exclusion from access list 450 by either the applicants 50a, 50b or 50c or Patent Filers 40. Of those abstracts that Patent Filers 40 can access, Patent Filers 40 can choose to communicate, via communication facilitation means of said other aspect of the present invention, with one or more applicants 50a, 50b or 50c in relation to their corresponding IP. In this particular example, registered IP rights platform 300, the communication facilitation means comprises text and graphic enabled communication boxes or other parts of, for example, a computer screen.

The registered IP rights platform 300 also includes all said features of said communication facilitation means of said other aspect of the present invention, which in this particular example, comprises all features of the method of applying for registered patent rights 20 of FIG. 1. Patent Filers 40 can therefore offer to agree as they did in relation to the example of the registered patent rights 20. However, they can also offer additional or alternative service arrangements comprising, for example, one or more of: an hourly charge basis; a fixed fee basis; or an all-inclusive basis.

Also included in the registered IP rights platform 300 are other features of said communication facilitation means of said other aspect of the present invention including the time recording means and corresponding features of the IP storage access means relating to conversion of viewing time to a corresponding charge. These features may, as would be readily apparent to persons skilled in the relevant art manifest in many different ways. One example of their incorporation into the IP rights platform 300 is as follows. Patent Filer 40 specifies a Charge Out rate, which can either be the same for all applicants 50a, 50b or 50c, or can be differentiated for specific applicants from charges for other applicants. When Patent Filer 40 is viewing the IP data referred to above their viewing time is recorded. Any time communicating with applicants 50a, 50b or 50c is also recorded. The recorded time is converted to a charge using the Charge Out rate referred to above.

However, before Patent Filer 40 is authorised to act for any one or more of applicants 50a, 50b or 50c, each of these applicants is required to preapprove an initial charge by Patent Filer 40 and provide those funds to the registered IP rights platform 300 for processing by Patent Filer 40. Patent Filer 40 also has a corresponding obligation before any one or more of applicants 50a, 50b or 50c can confirm that they would like Patent Filer 40 to act on their behalf, at least in a preliminary manner. They are required to confirm whether they will provide an initial period of time free of charge and if so what that period is and what it is likely to convert to in terms of the service or advice that applicants 50a, 50b or 50c are seeking.

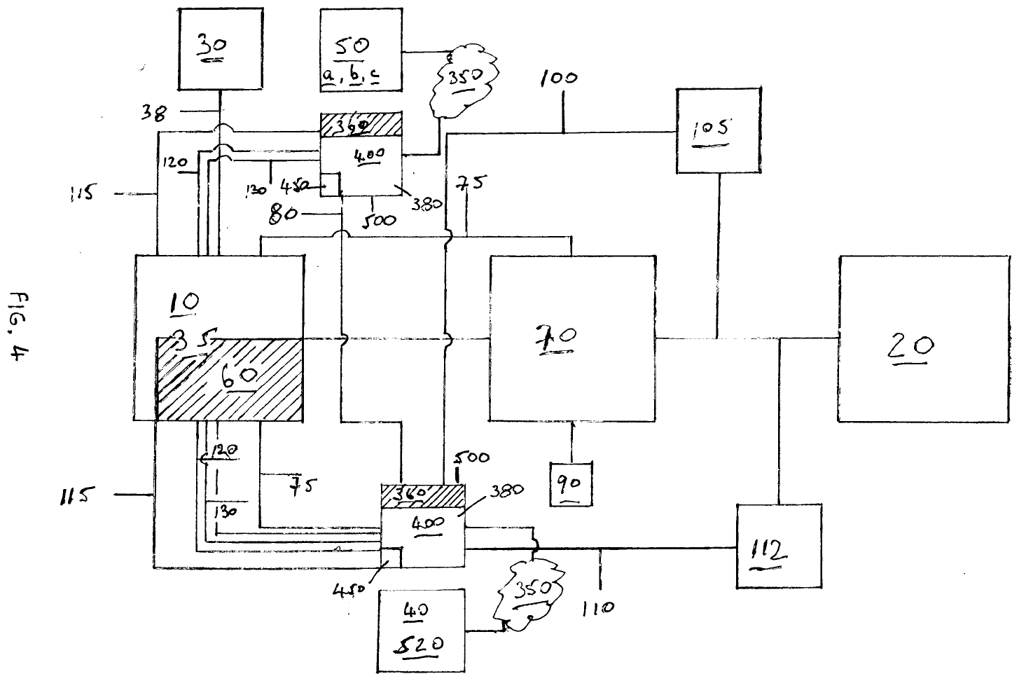

Referring to FIG. 4, another example of a programmable network of said other aspect of the present invention comprises a registered IP rights platform 500. The registered IP rights platform 500 is similar to the registered IP rights platform 300 in that it connects applicants 50a, 50b, 50c etcetera via the Internet 350 to Patent Filers 40. However, it differs in that it also connects applicants 50a, 50b, 50c etc to Other Patent Filers 520. The Other Patent Filers 520 includes any number of registering parties of the present invention.

The registered IP rights platform 500 also differs from the corresponding platform 300 of FIG. 3 as follows. The exclusion from access list 450 also quarantines Patent Filers 40 or any one or more said registering parties of the Other Patent Filers 520 from access to the IP of applicants 50a, 50b, 50c etc if, for example, those applicants have identified, in this particular example, said registering parties as being included in a corresponding exclusion list.

However, in relation to the IP rights platform 500, only registering parties of the programmable network of the present invention, which in relation to this particular example comprise Patent Filers 40 and Other Patent Filers 520, that are identified by the identity authorization means of the system of the present invention can access the abstracts. In this particular example, the identity authorization means comprises a database that is compiled from requested input from both Patent Filers 40 and Other Patent Filers 520 and applicants 50a, 50b and 50c. If no input is provided from a specific party to the IP rights platform 500, e.g. an applicant 50a or one of the Other Patent Filers 520, then a default position is selected in relation to that party. The default position of this particular example is, by way of example, that a corresponding abstract is made available by the applicant 50a that did not respond, or all abstracts are made available to the one of the Other Patent Filer 520 from which no response was received by the IP rights system 500.

The registered rights platform 500 also allows Patent Filers 40 and Other Patent Filers 520 to publish to applicants 50a, 50b, 50c etc. via proposal communication means of the programmable network of the present invention their proposal. This proposal may, for example, comprise features of the agreement between Patent Filers 40 and co-applicants 50 with respect to the method of applying for registered patent rights 20 of FIG. 1. However, it could also, for example, comprise any other terms of trade features. One or more of the applicants 50a, 50b, 50c etc. can then invite one or more of the service providers (Patent Filers 40 and Other Patent Filers 520) to access the secure IP section 360 in relation only to their IP, and assess it using assessment selection means of the programmable network of the present invention which in this particular example comprise ratings as, for example, used in relation to the methods 20 and 150 described above. Prior to these assessments the applicants 50a, 50b, 50c etc. would agree to the terms of trade of the invited parties, including any corresponding charges. After assessing or evaluating the IP the corresponding rating, for example the rating 90 of the method of applying for registered patent rights 20, would determine what services or work, if any, that any further proposal by any one or more of the Patent Filers 40 and Other Patent Filers 520 may comprise. Applicant 50a, 50b, 50c etc can then either accept or decline a corresponding service arrangement via agreement communication means of the programmable network of the present invention which in this particular example comprises accepting a corresponding agreement put forward by a service provider or provider of advice. Patent Filers 40 and Other Patent Filers 520 select the agreement via agreement selection means of the programmable network of the present invention which in this particular example comprises selecting an agreement from agreements drafted to correspond to 10 alternative proposals. However, Patent Filers 40 and Other Patent Filers 520 are also able to offer their own alternative agreement.

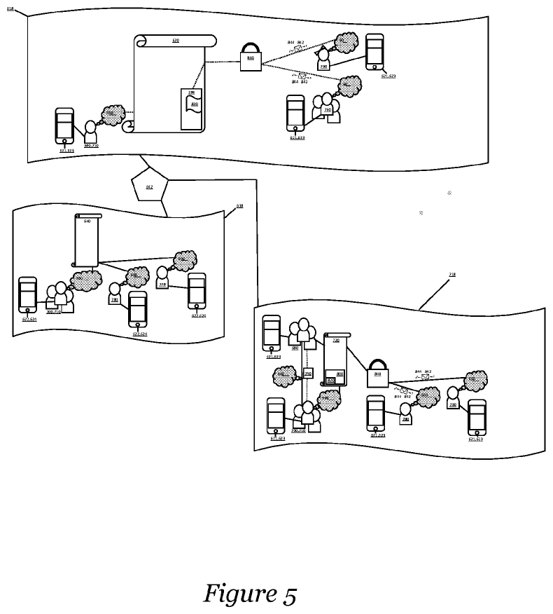

Referring to FIG. 5, another example of a programmable network of said other aspect of the present invention comprises a lawbook network 618 comprising any number of lawbooks 620. Lawbooks 620 is one particular example of an lawbooks relating to the programmable network of said other aspect of the present invention. The lawbook 620 relates in this particular example to mergers and acquisitions. However, in an alternative example the programmable network of said other aspect of the present invention comprises a lawbook network 638 having corresponding lawbooks 640 which relates to patent law. Both of these lawbooks 620 and 640 comprise respective Apps 621 and 622 that can be downloaded onto, for example, respective smart phones 623 and 624 for use of the corresponding Apps 621 and 622. However, the lawbooks 620 and 640 are not limited to use via corresponding Apps and therefore can be used on more conventional computers, for example, desktop PCs, notebooks or laptops.

The particular examples of lawbooks of the present invention, lawbooks 620 and 640 are web based and each of them connect via the internet 660 to a service seeker of said other aspect of the present invention which in this particular example comprises, for example, individuals or businesses 680 and 700 respectively and corresponding account holders 710. In this particular example, the individuals and businesses 680 and 700 respectively are not connected to each other via the internet 660 but in an alternative example, lawbook network 718 comprising corresponding lawbooks 720 they are and the additional connection of this particular embodiment is shown with hidden detail 740.

Each individuals or businesses 680 and 700 respectively can be the owner of, for example, one or more lawbooks 620, 640 or 720, or any other lawbook, which are described above or below. In relation to these particular example, and other examples of lawbooks included below, the lawbook owners, as opposed to lawbook network owners, are account holders of said other aspect of the present invention and in the particular examples of lawbook networks 618, 638 and 718, for example, and other lawbook networks described below, account holders 710.

The individuals and businesses 680 and 700 of lawbooks 620, 640 and 720 are however connectable to one or more service providers of said other aspect of the present invention which in this particular example respectively comprise, for example, lawyers 760 and patent attorneys 780.

Lawbook networks 618, 638 and 718 comprise one or more computers having data storage and processing capability. In this particular example these computers comprise, for example, corresponding terminal computers of the present invention which may, for example, comprise a pc or phone. The lawbooks referred to above corresponding to the lawbook networks 618, 638 and 718, for example, are therefore created or embodied via terminal computers such as those mentioned here. The data storage capability comprises brief storage means of said other aspect of the present invention which in the particular example of lawbooks 620 and 720 comprise a secure legal storage section 800. The secure legal section 800, in this particular example, comprises one or more hard drives and is designed so that legal related data 820 corresponding to each individual or business 680 and 700 respectively is only disclosed to or accessible to or visible by the corresponding individual or business. The IT related design of the secure legal section 800 comprises appropriate security features including, for example, password protection and 128 Bit encryption. However, it also includes any other security features that would be readily apparent to persons skilled in the relevant field.

The secure legal section 800 is disclosed to lawyers 760 via brief storage access means or brief storage disclosure means of the programmable network of said other aspect of the present invention which in this particular example comprises secure legal disclosure section 840. In this particular example, an opportunity to access the secure legal section 800 is provided to lawyers 760 by invitation 842 by the individuals and businesses 680 and 700 respectively. Upon acceptance 844 of a corresponding invitation 842 the secure legal section 800 is disclosed to a particular lawyer 760. The invitation 842 should only be accepted 844 if the lawyer first confirms that there is no conflict of interest in acting.

The data processing capability of the lawbook networks 618 and 718 comprise the secure legal disclosure section 840 which in this particular example comprises one or more computers comprising processors. The secure legal disclosure section 840 is designed to control access to the secure legal section 800 by lawyers 760. It is also designed to provide independent access to each said brief of said other aspect of the present invention which in this particular example comprises legal related data 820 corresponding to each individual or business 680 and 700.

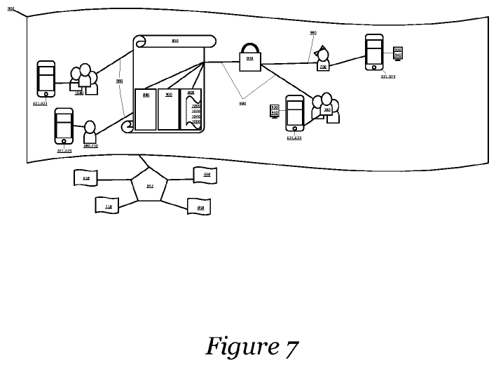

Lawbook network 858 comprising corresponding lawbooks 860 is an alternative embodiment to lawbook networks 618, 638 and 718 and is shown in FIG. 7. Unlike lawbook networks 618, 638 and 718, respective lawyers 760 and patent attorneys 780 are required to view, via a terminal computers of the present invention that they access the network 858 via, a corresponding said summary of said brief of said other aspect of the present invention which in these particular examples comprise respective legal and patent summaries 880 and 900 before the corresponding legal related data 820 or equivalent data of the lawbook 640 is authorised to be disclosed to the respective lawyers 760 and patent attorneys 780. The legal summaries 880 and 900 respectively only include publically available information and as such do not disclose any IP or any otherwise commercially sensitive information.

In an alternative preferred embodiment financebook, accountingbook, engineeringbook, designbook and architecturebook networks corresponding to the Lawbook network 858 and comprise respective equivalent corresponding financebooks, accountingbooks engineeringbook, designbook and architecturebook. These financebooks, accountingbooks, engineeringbooks, designbooks and architecturebooks have all of the features described above in relation to the lawbook network 858 and operate as described in relation to the lawbooks 860 except that they utilise software adapted for these other professions.

Examples are included below that concern lawbook networks 618, 638 and 718 and corresponding lawbooks, as well as other networks relating to other professions and corresponding books—for example—designbooks. However, for ease of description and reference purposes a single lawbook or other book (relating to another profession) network and corresponding lawbook or other book are described in relation to each example. Terminology used in relation to networks relating to professions comprising law or IP is, for ease of reference purposes, also applied to other professions. For example, while legal summaries 880 and 900 relate to lawbook networks and corresponding lawbooks this same descriptor or label also applies to networks and books relating to or comprising other professions.

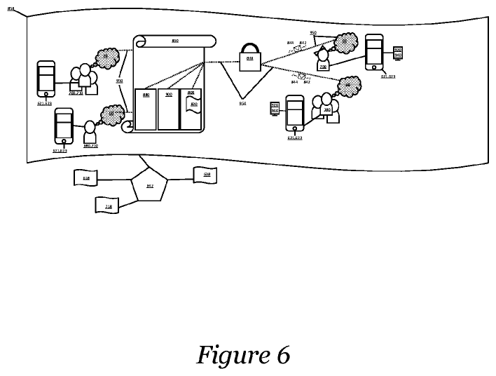

Referring to FIG. 6, of those respective legal and patent summaries 880 and 900 that a respective lawyer 760 and patent attorney 780 wishes to act in relation to, they can choose to communicate with the respective one or more individuals or businesses 680 and 700 in relation to the corresponding legal related data 820. This communication is carried out, in this particular example, via communication facilitation means of said other aspect of the present invention which in this particular example comprises smart phones 623 or PCs and associated monitors 920 and 940 respectively. Smart phones 623 and PCs and associated monitors 920 and 940 respectively provide communication channels of said other aspect of the present invention which in these particular examples comprise communications 950. In these particular examples the smart phones 623 and PCs and associated monitors 920 and 940 respectively are connected via the internet 60. In one preferred embodiment of the present invention the communication facilitation means of the present invention comprises the terminal computers of the network that they connect to.

In an alternative embodiment 960 shown in FIG. 7 the service or advice seeker and service provider or advisor of the present invention may, for example, be connected via a LAN 980. LAN embodiment 960 may, for example, be suitable for intra firm or intra organisation use. In this alternative example comprising LAN 980, one example of an image of a physical object, for example a machinery component other piece of equipment, of said other aspect of the present invention in the form of, for example, photographs 1,000, videos 1,020, drawings 1,040 and sketches 1,060 can be shared between colleagues 1,080 after respective legal (or other summaries relating to professions other than or including those relating to law) summaries 880 and 900 have been viewed by colleagues 1,080 and those colleagues have confirmed that there is no conflict of interest in the photographs 1,000, videos 1,020, drawings 1,040 and sketches 1,060 being disclosed to them.

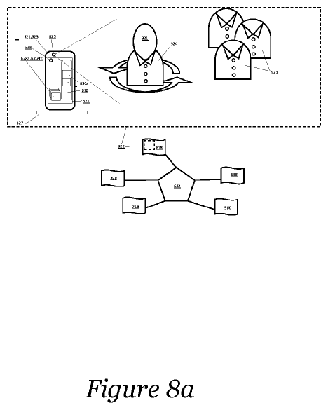

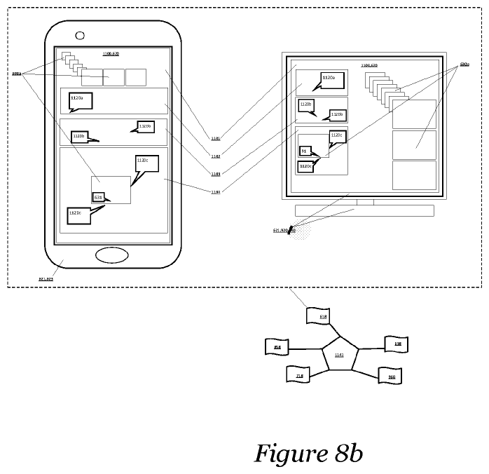

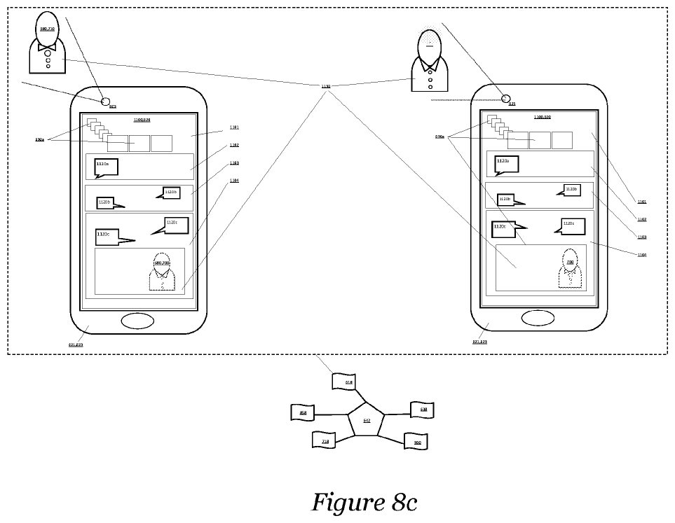

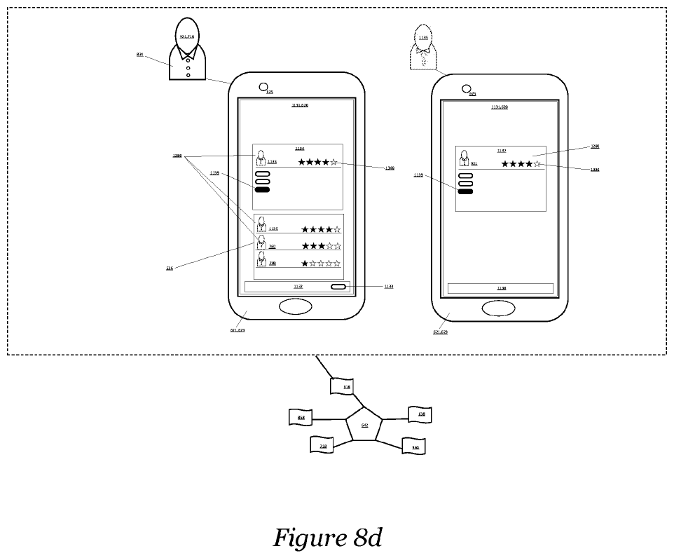

Referring to FIG. 8a, smart phones 623 provide examples, in the form of respective cameras 625, of image capture means of said other aspect of the present invention. In relation to the lawbook networks 618 John 921 goes to a law firm 922 to obtain some advice 923. John 921 decides that he would also like some advice on whether a shirt 924 is fashionable and could possibly even be protected in any way, for example by registered designs or copyright. John 921 decides that he will use the App 621, and an equivalent of that App that is associated with App 621 and relates to fashion design. He therefore places his phone 623 on a bench 627 to take a series of pictures 628a, b, c etc. while he rotates the shirt 924. Before rotating the shirt 924 he presses the snaps 629 icon of the App 621 and the corresponding App referred to above which is shown in the display 630 of the phone 623. The snaps 629 icon is designed to take about 10 pictures while John 621 turns the shirt 924 around. But the snaps 621 icon is also designed to include at least two photographs of each of the following views: front; left side; right side; rear. In this particular example, each of the photographs 630a are high resolution that readily allow manipulation.

With respect to the financebooks, accountingbooks, engineeringbooks, designbooks and architecturebooks referred to above, John 921 may require respective financial, accounting, engineering, design or architectural advice or services. John 921 can therefore use, as noted above, Apps corresponding to App 621 to take pictures or select video or sound clips, for example, of products, services, documents, sketches or anything else in relation to professions comprising those relating to, for example, one or more of the following that he requires services or advice in relation to: finance; accounting; engineering; design including graphic, book, print, web, environmental, information, interaction, experience, type, advertising, publishing, animation, game, transmedia, multi-media, motion graphics, fashion and other visual communication professions; and architecture.

Smart phones 623 and PCs and associated monitors 920 and 940 of lawbook networks 618 are also one example of image display means of said other aspect of the present invention. Referring to FIG. 8b, each PC and associated monitor 920 and 940 respectively is designed to display two or more different displays of said other aspect of the present invention. In relation to the particular examples of said other aspect of the present invention comprising lawbook or other professionalbook networks 618 the two or more different displays include a summary display of said other aspect of the present invention which in relation to these particular examples comprises lawbook or other professionalbook home page 1,100. The two or more different displays also include a discussion display of said other aspect of the present invention which in these particular examples comprise conversations 1,120a, 1,120b, 1,120c etc. Home page 1,100 and conversations 1,120a, 1,120b, 1,120c are shown in the respective displays 1,101, 1,102, 1,103 and 1,104 of smart phone 623 and monitor 940 which for the purpose of this particular example relate to App 621.

The lawbook or other professionalbook home page 1,100 of the lawbooks or other professionalbooks 620 is viewable by all lawyers or other professionals 760 that have accepted 844 invitations 842 by the individuals or businesses 680 and 700 respectively and can include, for example, the photographs 630a. lawbook home page 1,100 can only be modified though by lawbook or other professionalbooks account holders 710.

Contrary to lawbook or other professionalbooks homepage 1,100, conversations 1,120a, 1,120b, 1,120c are only disclosed to and therefore can only be accessed, or viewed by, persons or organisations of said other aspect of the present invention for which such disclosure is authorised. This authorisation is provided via said service provider discussion storage disclosure means of said other aspect of the present invention. In the particular examples of lawbooks or other professionalbooks 620 the service provider discussion storage disclosure means is incorporated into the secure legal disclosure section 840.

The conversations 1,120a, 1,120b, 1,120c can also include, for example, the photographs 630a. App 621 also enables, for example, comments 631 to be included within the conversations 1,120a, 1,120b, 1,120c in relation to any of the photographs 630a, or frames for example of a corresponding video. The comments can for example, comprise text or audio and the App 621 therefore also includes functionality for voice recording. In relation to the text comments these can, for example, be written over or beside the photographs or appended to the photographs and either open automatically or at the instruction of a user of the App 621.

Secure legal disclosure section 840 are designed to only provide a single paid lawyer or other professional 760 to each of the conversations 1,120a, 1,120b, 1,120c. Therefore, in relation to the lawbooks or other professionalbooks 620 if individual or business 680 or 700 wishes to pay more than one of the respective lawyers or other professionals 760 for an opinion or advice then that individual or business 680 or 700 will need at least two separate conversations 1,120a, 1,120b, 1,120c.

Any text or images, for example, can be added to the lawbook or other professionalbooks home page 1,100 by corresponding lawbook or other professionalbooks account holders 710. Text or images or audio clips, for example, can also be removed from lawbook or other professionalbooks home pages 1,100 by the corresponding lawbook or other professionalbooks account holders 710. The lawbook or other professionalbooks home pages 1,100 can therefore be altered and updated by the corresponding lawbook or other professionalbooks account holders 710. Any text, images or audio clips, for example, can be copied or summarised from any one or more of the conversations 1,120a, 1,120b, 1,120c, or in reverse from the lawbook or other professionalbooks home pages 1,100 to any one or more of the conversations 1,120a, 1,120b, 1,120c. Using the lawbook or other professionalbooks home pages 1,100, the lawbook or other professionalbooks 620 account holders 710 are therefore able to build a digital scrapbook of a collection of items or digital clippings, or in some cases an account holder may decide it is best to reduce the digital scrapbook to a single item, with the intention that their digital scrapbook will indicate or at least help to determine the look or feel or impression, for example, that they are hoping to achieve. For example, if a designbooks account holder 710 has opened an account for the purpose of their wedding then they can use the designbooks home page 1,100 to continuously update or modify the look that they are after with respect, for example, for the wedding reception or ceremony. However, in another example, a or other professionalbooks account holder 710 may have opened a designbook or architecturebook for the purpose of renovating their kitchen or house. In that example, the professionalbooks account holder 710 can use the professionalbooks home page 1,100 to continuously update or modify, via the collection of images or even audio clips, the overall feel or look or impression, for example, that they would like to achieve. The overall feel or look may not be readily apparent to a lay person. However, this may be apparent or discernable to persons or organisations having the relevant qualifications, or otherwise having attained the relevant skills, for understanding or interpreting the overall feel or look that the designbooks account holder 710 wishes to achieve.

At an interval period set, for example, by program design consultants pty ltd 642, lawyer or other professional 760 that have accepted 844 invitations 842 are notified of updates to the corresponding lawbook or other professionalbooks home pages 1,100. So, for example, if the interval period is one day then persons or organisations that have access to specific lawbook or other professionalbooks of the lawbook or other professionalbooks 620, for example, which have been created by a corresponding lawbook or other professionalbooks account holders 710, are notified every day that the corresponding lawbook or other professionalbooks home pages 1,100 are modified.

Unlike the updates of the home page 1,100, updates relating to each of the conversations 1,120a, 1,120b, 1,120c are not provided automatically. lawbook or other professionalbooks account holders 710 are responsible for pushing these through. In relation to lawbook or other professionalbooks 620, for example, lawyers or other professionals 760 for example that have access to conversations 1,120a, 1,120b, 1,120c are therefore notified of changes when the lawbook or other professionalbooks account holders 710 wishes for them to be notified. In this way, the lawbook or other professionalbooks account holders 710 can also manage update charges, relating to both the lawbook or other professionalbooks home pages 1,100 and conversations 1,120a, 1,120b, 1,120c, which are described below.

The charging system of the lawbook or other professionalbooks 620 for example, can for example, comprise charges for each update to the lawbook or other professionalbooks home pages 1,100 and conversations 1,120a, 1,120b, 1,120c. These charges would usually be small, for example 0.50 USD per update. In the particular examples of lawbook or other professionalbooks 620 the lawyers or other professionals 760 would usually be expected to keep abreast of the updates. The owner of the lawbook or other professionalbooks 620 for example, which in this particular example, comprises lawbook or other professionalbooks pty ltd, can determine how these update charges can be apportioned. For example, in some cases a percentage may flow to persons or businesses accessing the home page or conversations. In other examples however, only those persons or businesses booked for paid advice receive a percentage of these update charges. In another alternative preferred embodiment, the booking charges flow entirely to, for example, lawbook pty ltd.

Referring to FIG. 8c, as a result of conversations 1,120a, 1,120b, 1,120c one or more of the individuals or businesses 680 or 700 may desire, as defined in relation to said other aspect of the present invention, to retain or book one of the respective lawyers or other professionals 760 (which might comprise lawyers) and in the particular examples of lawbooks 620 elawbooking 1,130 enables this. Elawbooking 1,130 is made via booking means of said other aspect of said present invention and, with respect for example to lawbooks 620 retains or books one of the respective lawyers for their paid opinion or advise or other service. This paid opinion, advice or other service can relate, for example, to one or more of: legal related data 820 of lawbooks 620; lawbook home page 1,100; or one ore more discussions 1,120a, 1,120b, 1,120c.

Referring again to FIG. 8a and also FIG. 8d, subsequent to advice that John 921 received in relation to the shirt 924 he decides that he would like to use the App referred to above to arrange an in person meeting that afternoon at the law firm with the same person that advised him that morning. He unlocks his phone 623, opens App 621 and views display 1,131 shown in FIG. 8d. He then presses the “book meeting” icon 1,132. This takes him to window 1,132 and from that display he selects the “in person” icon 1,133. Window 1,134 is then visible and Harry's name, Harry 1,135 being the person that advised him previously, appears in a dropdown menu and is the only person in this menu because John 921 has not used App 621 before. John sees from window 1,134 that he could consider booking with someone else but decides that he liked Harry 1,135 and therefore selects his name from the dropdown menu. Window 1,137 appears and through a series of simple selections John 921 specifies that he would like an in person meeting that afternoon at the law firm. Harry 1,135 is free and accepts 1,138 John's invitation. John 921 is immediately presented with the options of a 1, 2 or 3 hour in person and in-office meeting. John decides he would like quite a bit of advice and so selects the “3 hours” option shown in window 1,139.

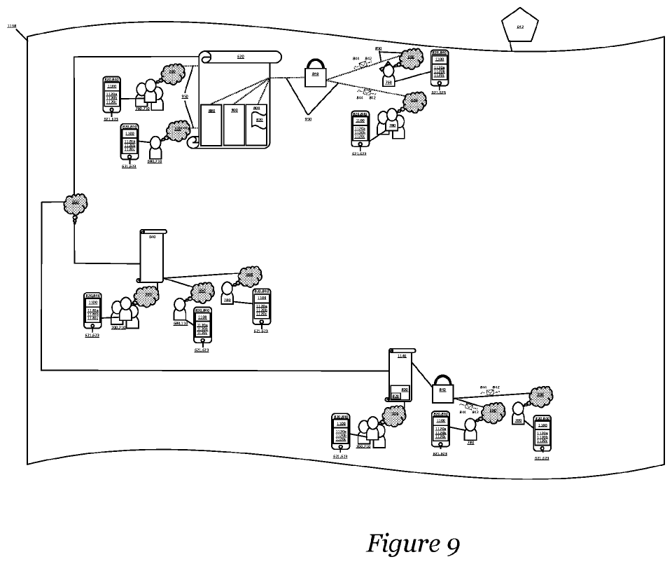

Referring to FIG. 9, lawbooks or other professionalbooks 620, 640, for example, can, in an alternative example of said other aspect of the present invention, be provided via a single programmable network of the present invention. In this particular example, a single programmable network comprises lawbook or other professionalbooks network 1,138 comprising corresponding lawbooks other professionalbooks 1,140. Any one or more of the networks described in the present description can also relate to one or more professions. In relation to such networks relating to more than one profession individuals or businesses 680 and 700, for example, can select one or more professions that they require professional services or advice in relation to. This can be provided, for example, via a dropdown menu or alternatively via a search icon. The professional service providers or advisors then accessed via, a terminal computer of the present invention in the form of, for example, a PC or smartphone of individuals or businesses 680 and 700 is then accordingly restricted.

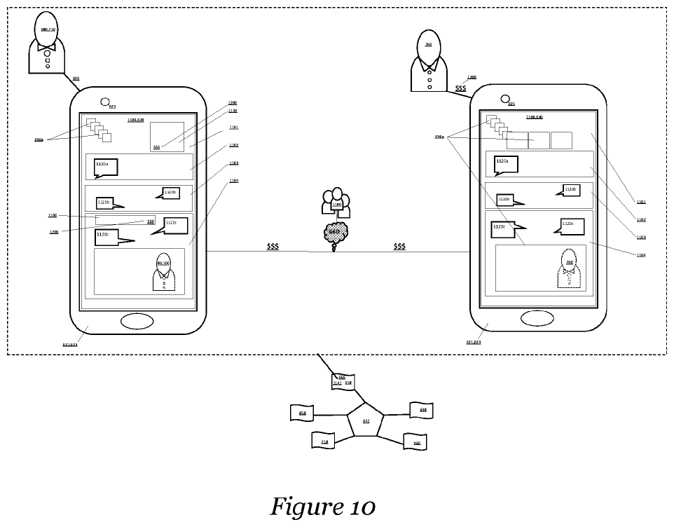

One example of paid advertising of said other aspect of the present invention comprise advertisements 1,160 shown in FIG. 10 which are displayed either on the lawbook home page 1,100 or with respect to one or more conversations 1,120a, 1,120b, 1,120c. With respect to these particular examples of a programmable network of said other aspect of the present invention specific metadata relating to legal related data 820 of lawbooks 620 is disclosed to advertisers 1,180 or any other third parties. These disclosures to advertisers 1,180, and other disclosures, are designed to enable advertisers 1,180 to target advertising, for example, in one or more of the following respects: geographical locations or regions; demographics; or in any other respect.

According to one preferred from of said credit receiving means of said other aspect of the present invention revenue from advertisements 1,160 which is one example of said payment of said other aspect of the present invention is applied, or in this particular example of said application of said other aspect of the present invention, is apportioned at least to one or more of the following: the owner or administrator of one or more of lawbook networks 618; individuals or businesses 680 and 700. Individuals or businesses 680 and 700 also receive service tokens 1,200 which are one example of said credited of said other aspect of the present invention. Service tokens 1,200 authorise the individuals or businesses 680 and 700 to obtain a respective service from lawyers 760 equivalent to a predetermined value of a corresponding paid service. In relation, at least, to the particular examples of lawbooks 620 the service tokens 1,200 apply to any of these, or other, lawbooks. However, the individuals or businesses 680 and 700 agree upon acceptance of the service tokens that they cannot be converted to the amount of the service tokens in cash or any other monetary equivalent. The service tokens 1,200 therefore only apply to the individuals or businesses 680 and 700 with respect to their use of any of these lawbook, or other, related or associated lawbooks.

Upon redemption of the service token 1,100 payment equivalent to the service token is made as follows. The service provider, for example, lawyer 760 receives their allotted payment. The owner of the lawbook networks 618, for example, which in this particular example, comprises lawbook pty ltd 1,141, also receives their share of the payment corresponding to service token 1,100.

Referring to FIG. 10 and also FIGS. 8a and 8d, John 921 is notified that he has service tokens to the value of $500. He can also see that to book an in person, in-office meeting with Harry 1,135 for the time requested will cost him $900. John accepts and he is asked to enter his credit card details. He does so and Harry 1,135 receives a notification, on his phone 623 confirming the meeting and that payment has been received. Harry therefore meets John at the scheduled time. They are about to move onto a different legal issue when they both receive via their phones notifications that the allocated time has expired. John is happy to spend some more time and money receiving advice from Harry and therefore selects the appropriate icon from the display of his phone 623 and in doing so agrees that his credit card be charged for an additional 1 hour of Harry's time. Harry is accordingly notified and the in person, in-office meeting continues for another hour.

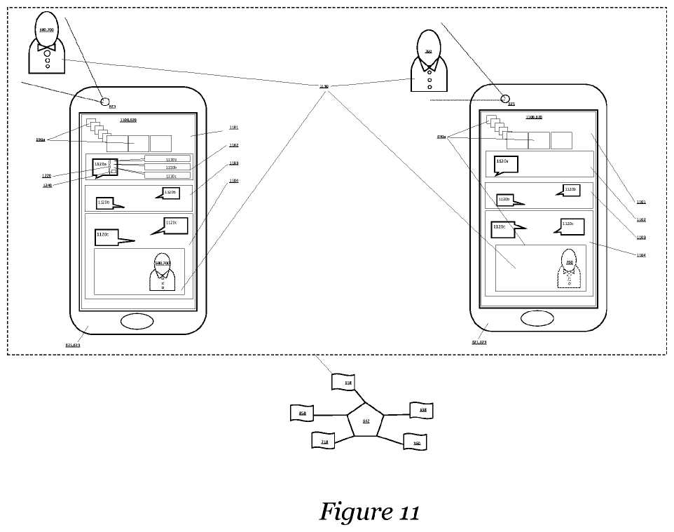

Referring to FIG. 11, conversations 1,120a of FIG. 6 are split 1,220 into conversations 1,230a, 1,230b, 1,230c etc. by communications splitters 1,240 which are one example of said branching means of said other aspect of the present invention. Each of the conversations 1,230a, 1,230b, 1,230c etc. include respective lawyers. Said communicants of said each new communication channel of said other aspect of the present invention comprise in these particular examples lawyers 760 involved in the conversations 1230a, 1230a, 1230c etc. The one or more conversations 1,120a, 1,120b, 1,120c shown in FIG. 8 are incorporated into conversations 1,230a, 1,230b, 1,230c etc. Lawyers 760 that are not included in conversations 1,230a, 1,230b, 1,230c etc. are not informed of conversations 1,230a, 1,230b, 1,230c etc. An advantage of the splitting 1,220 is that conversations 1,120a, 1,120b, 1,120c can be modified or adjusted, for example, as thought to be best modified by the individuals or businesses 680 or 700 respectively.

Lawbook networks 618 also include assessing means of said other aspect of the present invention which in these particular examples comprises matching system 1,280 which is shown in FIG. 8d when considered in combination with FIGS. 8a, 8b and 8c and also the other figures of the Detailed Description of the Preferred Embodiment. The matching system 1,280 is designed for matching individuals and businesses 680 and 700 respectively with lawyers 760. For this purpose, the matching system 1,280 includes credentials storage means of said other aspect of the present invention which in these particular examples take the respective form of one or more hard drives relating, for example, to lawyers such as Harry 1,135. It also includes achievements of, for example, the individuals and businesses 680 and 700 respectively and, in relation to these particular examples, appropriately stored in the respective hard drives.

The hard drive is located within said service provider storage means of said other aspect of the present invention which in this particular example comprises a secure legal section of lawyers 760 of lawbook networks 618 similar or equivalent to the secure legal section 840. However, this data could in an alternative preferred embodiment be stored in any other location of the lawbook network 618 which is determined appropriate by persons skilled in the relevant art in keeping with the purpose and functionality of the lawbook network 618.

Credentials storage means of said other aspect of the present invention in the particular examples of lawbook networks 618 also take the form of one or more hard drives relating respectively to individuals 680 and businesses 700. In these particular examples credentials of said other aspect of the present invention similarly include achievements of the individuals and businesses 680 and 700 respectively. The achievements are populated by individuals and businesses 680 and 700 respectively and stored in a corresponding manner to that described above in relation to the achievements of, for example, the lawyers 760

Achievements described above are disclosed upon acceptance 844 by lawyers 760 of a corresponding invitation 842 from individuals and businesses 680 and 700 respectively.

The matching system 1,280 also includes ratings of said other aspect of the present invention which in these particular examples comprise stars 1,330. The individuals and businesses 680 and 700 respectively, or a designer, administrator or owner of the lawbook networks 618, for example, for example program design consultants pty ltd 642, allocate either 1, 2, 3, 4 or 5 stars to any given lawyer based on either their performance or their anticipated performance in light of their respective achievements. The stars 1,330 are cumulative with respect to each lawyer 760. However, in these particular examples weightings are also applied to stars 1,330 allocated by the individuals and businesses 680 and 700 respectively, or a designer, administrator or owner of the lawbook networks 618, 638, 718, 858 and 1,138.

Similar ratings can also be similarly allocated in relation to the individuals and businesses 680 and 700 respectively. These corresponding ratings in the particular example of matching system 1,280 comprise stars 1,340. Stars 1,340 are allocated as described in relation to the stars 1,330 but by lawyers 760, for example, instead of individuals and businesses 680 and 700 respectively.

In relation to the step of assessing of said yet other aspect of the present invention which in the particular examples of lawbook networks 618, for example, involves matching system 1,280, stars 1,330 and 1,340 are used by, in this particular example, program design consultants pty ltd 642. They can use them to recommend, determine or control matching of the individuals or businesses 680 or 700 respectively with lawyers 760.

Lawbook networks or other professionalbooks 618 also include disclosure exclusion means of said other aspect of the present invention which in these particular examples includes disclosure prevention databases. These databases relate to individuals or businesses 680 or 700 respectively and in the particular examples of lawbooks 620 is included in hard drives. It also correspondingly relates to lawyers 760. The disclosure prevention database identifies lawyers 760 that individuals or businesses 680 or 700 respectively do not wish to receive a service from and hence to not wish to be included as possible invitees of invitations 842. In the same way, the disclosure prevention database identifies individuals or businesses 680 or 700 respectively that lawyers 760 do not wish to provide a service to and hence similarly do not wish to be included as a possible invitee of invitations 842. The database also includes the functionality that enables lawyers, for example, to identify categories of individuals or businesses 680 or 700 respectively, or technologies, professions or industries in respect of which they do not wish to provide a service to and hence to not wish to be included as a possible invitee of invitations 842.

Referring to FIG. 5, and lawbook 620 first referenced above in relation to FIG. 5, lawbook or other professionalbooks network 618 also includes another feature which relates to the legal summaries 880 (see FIGS. 6 and 9). This other feature comprises the IP feedback means (or feedback relating to one or more other professions) of said other aspect of the present invention and in the particular example of the lawbook 620 comprises an IP key facts icon. The key facts icon provides access to information which corresponds to the summaries 880 but unlike those summaries this information isn't just information which is publically available. The key facts icon also includes its own conversations equivalent, for example to conversations 1,120a, 1,120b, 1,120c referred to above. The key facts icon enables any and all aspects of, for example, legal related data 820 to be considered and commented on by, for example, the lawyers 760 or any of their associates or advisors. The key facts icon therefore enables, for example, the individuals or businesses 680 or 700 respectively to quickly and efficiently obtain feedback in relation to any combination of details relating to their IP, which in the particular examples referred to above comprises, for example, their legal related data 820.

The advantages of the key facts icon feature are therefore potentially numerous. For example, in relation to the IP field, the individuals or businesses 680 or 700 respectively can potentially much more quickly and cost effectively gauge the commercial viability of an invention by quickly, easily and confidentially opening up their idea to any number of advisors for their feedback. However, this functionality also applies to non-IP related professions. In seeking or obtaining this feedback information disclosed via the key facts icon therefore does not become publically available and will not jeopardise corresponding registerable IP rights.

Advisors involved in relation to the key facts icon include, for example, the lawyers 760 and patent attorneys 780 of lawbook 620 for example. However, lawbook 620, or other examples of said other aspect of the present invention, is not limited to these categories of advisors. Any other professional service providers, for example those disclosed in this description, and also non-professionals can offer a service or opinion for example, via the lawbook 620 in the same way that lawyers 760 and patent attorneys 780 can. For example, an opinion might be sought from a business person as to the commercial viability. Conflicts of interest will typically not be of the same significance however to these non- professionals, and not relevant to some of the non-legal professionals, and they may not be required to keep confidential information disclosed to them in relation to IP of the individuals or businesses 680 or 700 respectively. Therefore, for individuals or businesses 680 or 700 considering allowing professionals other than the lawyers 760 and patent attorneys 780 or non-professionals access to their legal related data of lawbook 620 which is equivalent to the legal related data 820 they need to first give consideration to these conflict of interest and confidentiality issues. For significant IP the safest approach would most likely be for the individuals and businesses 680 and 700 to only engage directly with the lawyers 760 and patent attorneys 780. Other professionals or non-professionals can then be engaged through the lawyers 760 and patent attorneys 780. The lawyers 760 and patent attorneys 780 can then manage and control these conflict of interest and confidentiality issues.

For reasons explained above in relation to the key facts icon concerning conflict of interest and confidentiality issues, lawyers 760 and patent attorneys 780, in this particular preferred embodiment, need to declare upon registration with lawbook 620 for example that they are in fact a lawyer or patent attorney respectively. Lawbook 620 therefore includes the ability to accept proof of registration documents to enable claims of registration to be verified with the relevant registering organisations. Until verified the lawbook 620 notes that the lawyer or patent attorney 760 and 780 respectively claims to have appropriate authorisation to practice but that this claim is yet to be verified. Upon verification, the lawbook 620 refers to the lawyer or patent attorneys 760 and 780 respectively as respective lawyers and patent attorneys.

If registered IP rights are sought, then the key facts icon feature would typically best only be used after filing of corresponding applications for registration of corresponding registered IP rights. However, in some cases individuals or businesses 680 or 700 respectively may wish to obtain preliminary advice on, for example, registrability or commercial viability before they pursue corresponding registered IP rights. The key facts icon could also be used, for example, for seeking preliminary infringement advice.

Referring to FIG. 5, lawbook 620, for example, first referenced above in relation to FIG. 2, also includes another feature which relates to the funding of services provided, for example, by the lawyers 760 and patent attorneys 780 or funding related to commercialisation of IP, for example, IP of the individuals or businesses 680 or 700 respectively. This other feature comprises the commercial assistance means of said other aspect of the present invention which in this particular example comprises a commercialisation icon. Although the funding of services related to the IP of the individuals or businesses 680 or 700 respectively is not directly related to commercialization, reducing or fixing legal fees, for example, assists commercialisation.

The commercialisation icon is designed to facilitate one or more commercial aspects relating to IP of the individuals or businesses 680 or 700 respectively including, for example, licensing or assigning of the IP or raising capital, for example, using Crowd Funding Websites such as KickStarter. It also provides the option of lawyers 760 and patent attorneys 780 offering one or more services relating to IP of the individuals or businesses 680 or 700 respectively in return, for example, for a percentage of revenue or equity relating to commercialisation of the IP of the individuals or businesses 680 or 700 respectively which the lawyers 760 and patent attorneys 780 act in relation to.

The communication facilitation means of said other aspect of the present invention which is described above, for example, in relation to FIG. 6 comprises the commercialisation icon. Referring again to figure 5, by selecting the commercialisation icon a user, for example an individual or business 680 or 700 respectively, is then presented with the options generally described above of obtaining assistance with: legal services icon; assigning or licencing IP rights (registered or otherwise) icon; or raising capital icon.

Selecting legal services icon provides access to a database of, for example, lawyers and patent attorneys which are a subset of the lawyers and patent attorneys 760 and 780 described above. This subset indicated when prompted, either at sign up or a later date, that they offer a service arrangement which the legal services icon relates to. These service arrangements, for example offering services in return for a percentage of revenue that may later be derived from the corresponding IP, can be negotiated specifically or can also be selected or guided by predetermined options which are presented upon selection of the legal services icon.

The other icons operate in a similar way to the legal services icon. They allow direct communication with professional or capital raising organisations or individuals that are appropriately qualified and have agreed to provide their services via the respective icons and communicate directly with organisations or individuals via, for example, the lawbook 860.

The commercialisation icon also retains confidentiality, particularly when used via the lawbook 860 for example, as explained above in relation to the key facts icon, and then when also used via lawyers 760 and patent attorneys 780 which have been verified by lawbook 620 as being authorised to practice as lawyers and patent attorneys respectively. The key facts icon and commercialisation icon also include all other functionality described above, for example, in relation to lawbook 620 and therefore also protect against conflicts of interest. Booking functionality described above equivalent to elawbooking 1,130 is, for example, therefore also available when using these icons. This booking functionality enables, for example, one of the respective lawyers 760 and patent attorneys 780 to be retained for their paid advice in relation to, for example, specific aspects of the legal related data 820 or equivalent data of the lawbook 620 as specified by the key facts icon. It also enables, for example, a patent attorney 780 to engage an assignment or licensing expert to provide services sought via the assignment or licensing icon.

It will be appreciated that the invention in at least one of its preferred forms has at least the following possible advantages:
1. persons requiring professional services or advice can quickly, efficiently and cost effectively access numerous professional services advisors and practices. This makes it easier for persons seeking these services and advice to compare pricing and services. It also increases the likelihood of reduced pricing or enhanced services by increasing competition between professional services providers
2. professional service providers and advisors and their practices have increased access to potential clients and can efficiently and effectively select those clients that they wish to act in relation to, either on the basis of conflicts of interest or client demographic. This reduces the administrative process in identifying and engaging clients and therefore enables professional service providers and advisors and their practices to be more competitively priced
3. professional service providers and advisors and their practices have the ability to choose whether to access a clients' brief on the basis of a corresponding higher-level summary brief which only includes publically available information. This feature enables conflicts of interest to be avoided. It also enables professional service providers and advisors and their practices to more quickly and efficiently identify work that they wish to be involved in without considering detail that is unnecessary either if they choose to not act in relation to a brief or are not engaged by the corresponding service or advice seeker. In light, at least, of the relatively recent growth in importance of visual communication professions and the corresponding coincidental growth in on-line services, referred to at item 19 below, conflict avoidance or efficient consideration of potential client briefs, or both, is becoming increasingly important;
4. inventors and other IP owners and originators and corresponding prospective applicants for corresponding registered IP rights have increased certainty about the application process and its cost;
5. inventors and other IP owners and originators and corresponding prospective applicants for corresponding registered IP rights also have increased certainty concerning commercialisation of the IP including the corresponding process and its cost;
6. costs identified at items 4 and 5 are typically at least substantially, but possibly more likely vastly, reduced;
7. advantages corresponding to those of items 4 to 6 above in relation to other services and advice, for example, other legal services and advice;
8. charges and corresponding services of competing service providers, for example, Patent Filers 40 and Patent and Trademark Filers 170, that may be engaged, for example, by inventors and other IP owners and originators and corresponding prospective applicants at least for corresponding registered IP rights but possibly also corresponding commercialisation, are at least likely to be more easily compared. This is at least likely to make these charges and corresponding processes more transparent and comparable and lead to reduced costs for, for example, applying for and obtaining registered IP rights, and increased certainty concerning the corresponding process;
9. professional service providers or advisors, for example, Patent Filers 40 and Patent and Trademark Filers 170, that may be engaged, for example, by inventors and other IP owners and originators and corresponding prospective applicants for corresponding registered IP rights and commercialisation of the IP are focused solely, for example, on the IP, its protection and corresponding commercial returns. There is no possible conflict of interest for these service providers between serving those whom engage them and generating revenue for their services. Service provider remuneration is directly linked, for example, to commercialisation of the IP and unrelated to any other measure of service provider input, for example, time spent or hours billed;
10. the registered rights platforms 300 and 500 also apply, for service and advice providers, intra firm. That is, service providers and advisers of, for example, the same firm can also communicate via the registered rights platforms 300 and 500, for example. One of the advantages of this application of said other aspect and yet other aspect of the present invention is that information relating to a client is only disclosed, for example, to specific lawyers or patent attorneys whom are employed by or part owners of, for example, a firm or company of lawyers or patent attorneys. This application may also be useful, for example, in providing more effective “Chinese Walls” which may enable more legal firms or companies to represent clients having related to conflicting legal rights or competing interests;
11. a service or advice seeker can quickly and easily obtain an opinion, advice or other service from any number of relevant service providers. This enables such services to be transportable and in a most preferred form of the present invention readily and quickly accessible to the extent that it is essentially equivalent to a service seeker taking an advisor, paid or otherwise, with them;
12. a service or advice seeker and professional service provider or advisor each have control over disclosure of their details and details of a component, equipment or machinery, design, sketch or anything else which the advice or other service relates to;
13. a service or advice seeker or professional service provider or advisor have access to a ratings system which facilitates identification and selection for both of these parties and, in a most preferred form of the present invention, is at least likely to result in significant time savings and a better and more effective match and hence an increased likelihood of a beneficial and valued outcome;
14. a service or advice seeker has ready access, via conversations, to any number of comments, feedback or other opinions or advice. He or she or they also have the ability to branch those conversations to their benefit by, for example, retaining some parties of any particular discussion and thereby excluding others;
15. a service or advice seeker is able to easily and quickly book a paid service. That paid service can then be managed as required to, for example, ensure that the service is limited to a specified budget;
16. advertising is integrally linked for the benefit of the service or advice seeker. Benefits also flow to advertisers because it provides the advantage to them to target their advertising and hence make any advertising spend more cost effective. However, the service or advice seeker benefits because some of the advertising revenue is passed on directly to them. In return, advertisers obtain valuable information about industries more cost effectively;
17. a professional service provider or advisor is able to easily and quickly identify or prevent conflicts of interest. They also have the ability to selectively access a market and hence identify or specify clients that they wish to service;
18. advantages, as applicable, corresponding to items 4 to 10 above also apply to professions other than those comprising IP including, for example, professions comprising those relating to finance, accounting, engineering, design including graphic, book, print, web, environmental, information, interaction, experience, type, advertising, publishing, animation, game, transmedia, multi-media, motion graphics, fashion and other visual communication professions, and architecture;
19. with the recent growth in on-line products and services advantages of the present invention, including those of items 1 to 18 above and also other identified in the present description, help to reduce possible inherent limitations with on-line services that are apparent from item 3 at least and the present description; and
20. it is adapted to comprise or facilitate visual language communication comprising, for example, one or more of digital, physical and analogue media and can further comprise, for example, topography, interaction and image making.

It will be appreciated by persons skilled in the art that numerous variations or modifications may be made to the invention as shown in the specific embodiments without departing from the spirit or scope of the invention as broadly described. For example, any one or more features of any one or more of the lawbook networks 618, 638, 718, 858 and 960, for example, not comprised in the registered IP rights platforms 300 or 500 can be included in those platforms. This might mean, for example, that such modified platforms 300 and 500 function as any one or more of the networks 618, 638, 718, 858 and 960 with the exception, for example, that they don't comprise the corresponding lawbooks or other professionalbooks that these lawbook or other professionalbook networks comprise. In one preferred embodiment, these modified platforms 300 and 500 comprise one or more features which are available via the corresponding lawbooks however instead of this functionality comprising the corresponding lawbooks it comprises, for example, the terminal computers which are described in relation to the platforms 300 and 500 but without the actual lawbooks. In another variation or modification of the IP rights platforms 300 and 500, they again function, for example, as any one or more of the networks 618, 638, 718, 858 and 960, or comprising any one or more features of those networks, but also in relation to professions other than or as well as the legal or IP professions. For example, such modified platforms or programmable networks could be designed to relate to professions comprising those relating to one or more of the following: finance; accounting; engineering; design including graphic, book, print, web, environmental, information, interaction, experience, type, advertising, publishing, animation, game, transmedia, multi-media, motion graphics, fashion and other visual communication professions; and architecture. In relation to this other variation or modification one or more professional service or advice seekers or one or more professional service providers or advisors of the present invention communicate with one or more of each other via the modified platforms 300 and 500 using terminal computers of those platforms which comprise, for example, computers or smartphones arranged for communication with the modified platforms 300 or 500. In yet another variation or modification of the present invention any one or more of the IP rights platforms 300 and 500, or corresponding modified platforms, and the networks 618, 638, 718, 858 and 960 can, for example, be adapted with appropriate software modifications for other professional services or advice, for example, those comprising professions relating to one or more of the following: geology; medicine; physiotherapy; podiatry; and dentistry.

In another example of a variation or modification registered design rights may be the subject of the method of the present invention of applying for registered IP rights.

In still another example the relationship between assessments fees such as 80 and 200, corresponding respective ratings 90 and 250 and corresponding respective exploitation revenue percentages of 30 and 15 may be different to these examples or those defined in the summary of the invention section of the present specification.

In yet another example, different advertising revenue flows might be desirable. For example, advertising revenue might flow predominantly or exclusively to service providers and service providers then in turn might provide more advice without charging a service seeker.

The present embodiments are, therefore, to be considered in all respects as illustrative and not restrictive.

The claims defining the invention are as follows:

1. A terminal computer arranged for obtaining or providing professional services or advice, said terminal computer being arranged for communication with a programmable network comprising brief storage means for storing a brief of one or more professional service or advice seekers seeking a corresponding service or corresponding advice, and professional service provider or advisor brief storage access means arranged for enabling access by one or more professional service providers or advisors to said brief storage means, wherein said brief storage access means is further arranged for selective access by each of said one or more professional service providers or advisors to each said brief of said one or more professional service or advice seekers.

2. A terminal computer as claimed in claim 1 wherein said brief storage access means further comprises time recording means arranged to record time spent by said one or more professional service providers or advisors viewing said brief.

3. A terminal computer as claimed in claim 1 or claim 2 wherein said professional service provider or advisor brief storage access means is further arranged to identify one or more of said one or more professional service or advice seekers or said one or more professional service providers or advisors with respect to any one or more of said one or more professional service providers or advisors, any one or more of said one or more professional service or advice seekers, or both.

4. A terminal computer as claimed in any one or more of the preceding claims wherein said programmable network further comprises professional service provider or advisor storage means arranged for storing information relating to one or more of said one or more professional service providers or advisors.

5. A terminal computer as claimed in any one or more of the preceding claims wherein said programmable network further comprises communication facilitation means arranged for at least partially facilitating respective communication between one or more of said one or more professional service or advice seekers or said one or more professional service providers or advisors and any one or more of said one or more professional service providers or advisors, any one or more other of said one or more professional service or advice seekers, or both.

6. A terminal computer as claimed in any one or more of the preceding claims wherein said professional service provider or advisor brief storage access means comprises authorisation means arranged for authorising said access.

7. A terminal computer as claimed in claim 6 wherein said authorisation means is arranged to authorise said access via an invitation of one or more of said professional service or advice seeker to one or more of said one or more professional service provider or advisor to access their corresponding brief.

8. A terminal computer as claimed in any one or more of the preceding claims wherein said professional service provider or advisor brief storage access means further comprises brief summary means for providing a summary of said brief relating to one or more of said one or more professional service or advice seekers.

9. A terminal computer as claimed in claim 8 wherein said authorisation means is further arranged to only authorise access in relation to each said brief by one or more of said one or more professional service providers or advisors upon confirmation by a corresponding professional service provider or advisor that they have reviewed said brief summary and do not have a conflict of interest in acting in relation to the corresponding brief.

10. A terminal computer as claimed in claim 8 or claim 9 wherein said brief summary only comprises publically available information relating to said brief.

11. A terminal computer as claimed in any one or more of the preceding claims wherein said professional service provider or advisor brief storage access means comprises identity authorisation means arranged for identifying one or more of: one or more of said professional service providers or advisors authorised by one or more of said one or more professional service or advice seekers to act on their behalf; or one or more of said professional service or advice seekers which one or more of said professional service providers or advisors authorise that they can act on behalf of.

12. A terminal computer as claimed in any one or more of the preceding claims wherein said professional service provider or advisor brief storage access means further comprises authorisation exclusion means arranged for identifying prospective professional service or advice seekers or professional service providers or advisors, including categories of these, for whom said authorisation is not provided.

13. A method of operating a terminal computer arranged for obtaining or providing professional services or advice, said terminal computer being arranged for communication with a programmable network comprising brief storage means for storing a brief of one or more professional service or advice seekers seeking a corresponding service or corresponding advice, and professional service provider or advisor brief storage access means arranged for enabling access by one or more professional service providers or advisors to said brief storage means, said method comprising the steps of:
a. Storing, via said brief storage means, a brief of one or more professional service or advice seekers seeking a corresponding service or corresponding advice; and
b. one or more professional service providers or advisors selectively accessing, via said professional service provider or advisor brief storage access means, each said brief of said one or more professional service or advice seekers.

14. A method of obtaining or providing professional services or advice, said method comprising the steps of:
a. storing a brief of one or more professional service or advice seekers seeking a corresponding service or corresponding advice; and
b. one or more professional service providers or advisors selectively accessing each said brief of said one or more professional service or advice seekers.

15. A method as claimed in claim 14 further comprising the step of identifying one or more of said one or more professional service or advice seekers or said one or more professional service providers or advisors with respect to any one or more of said one or more professional service providers or advisors, any one or more of said one or more professional service or advice seekers, or both.

16. A method as claimed in claim 14 or claim 15 wherein said method comprises a method of applying for or obtaining registered IP rights.

17. A method as claimed in any one or more of claims 14 to 16 further comprising the step of any one or more of said professional service provider or advisor authorising their access to said brief of any one or more of said one or more professional service or advice seeker.

18. A method as claimed in claims 17 further comprising the preceding step of providing a brief summary summarising said brief relating to one or more of said one or more professional service or advice seekers.

19. A method as claimed in claims 18 wherein said step of providing said brief summary further comprises the step of providing a summary which only includes publically available information.

20. A method as claimed in any one or more of claims 17 to 19 wherein said access authorisation step further comprises the step of authorising access only in relation to each said brief by one or more of said one or more professional service providers or advisors upon confirmation by a corresponding professional service provider or advisor that they have reviewed said brief summary and do not have a conflict of interest in acting in relation to said corresponding brief.

21. A method as claimed in any one or more of claims 17 to 20 wherein said authorising step further comprises the step of authorising said access via an invitation of one or more of said one or more professional service or advice seekers to one or more of said one or more professional service provider or advisors to access their corresponding brief.

22. A method as claimed in any one or more of claims 14 to 21 further comprising the step of facilitating communication between one or more of said one or more professional service or advice seekers or said one or more professional service providers or advisors with respect to any one or more of said one or more professional service providers or advisors, any one or more of said one or more professional service or advice seekers, or both.

23. A method of operating a terminal computer as claimed in claim 13 wherein said terminal computer comprises said terminal computer of any one or more of claims 1 to 12.

24. A terminal computer as claimed in any one or more of claims 1 to 12 wherein said professional services or advice comprises professions relating to one or more of the following: law; finance; accounting; engineering; design, including graphic, book, print, web, environmental, information, interaction, experience, type, advertising, publishing, animation, game, transmedia, multi-media, motion graphics, fashion and other visual communication professions; and architecture.

25. A method of operating a terminal computer as claimed in claim 13 or claim 23 wherein said professional services or advice comprises professions relating to one or more of the following: law; finance; accounting; engineering; design, including graphic, book, print, web, environmental, information, interaction, experience, type, advertising, publishing, animation, game, transmedia, multi-media, motion graphics, fashion and other visual communication professions; and architecture.

26. A method as claimed in any one or more of claims 14 to 22 wherein said professional services or advice comprises professions relating to one or more of the following: law; finance; accounting; engineering; design, including graphic, book, print, web, environmental, information, interaction, experience, type, advertising, publishing, animation, game, transmedia, multi-media, motion graphics, fashion and other visual communication professions; and architecture.

27. A terminal computer as claimed in any one or more of claims 1 to 12 wherein said brief comprises IP of an owner or originator of said IP or a prospective applicant of an application for registration of corresponding registered IP rights.
